(19) United States
(12) Patent Application Publication
(10) Pub. No.: US 2014/0259038 A1
(43) Pub. Date: Sep. 11, 2014

(54) DEMOGRAPHIC PREDICTION CHANNEL

(71) Applicants: Leonid Belyaev, Moscow (RU); Igor Sokolov, Tver (RU); Ilya Baronshin, Saint Petersburg (RU)

(72) Inventors: Leonid Belyaev, Moscow (RU); Igor Sokolov, Tver (RU); Ilya Baronshin, Saint Petersburg (RU)

(73) Assignee: Rawllin International Inc., Tortola (VG)

(21) Appl. No.: 13/789,378

(22) Filed: Mar. 7, 2013

(51) Int. Cl. H04N 21/442

(52) U.S. Cl. CPC H04N 21/44213
USPC 725/14

(57) ABSTRACT

Video content is identified by a source component via a processor from a plurality of media sources comprising at least two of a wireless broadcast media channel, a web site, a web data feed, and/or a wired broadcast channel for communication via a personalized video channel. A demographic component is configured to classify a user device in a demographic class based on demographic data. A set of predicted video content is generated from the video content of the plurality of media sources based on the demographic data with a prediction component. A streaming component is configured to communicate the set of predicted video content from the plurality of media sources to a mobile component via the personalized video channel and re-configure the personalized video channel to communicate, at different times, the video content identified from different media sources of the plurality of media sources.

### TECHNICAL FIELD

The subject application relates to video content, and, in particular, to personalizing and aggregating demographic predictions of video content.

### BACKGROUND

Media content can consist of various forms of media and the contents that make up the different forms of media. For example, a film, video, movie or motion picture can comprise a series of still or moving images that are rapidly put together and projected onto/from a display. The video is produced by recording photographic images with cameras, or by creating images using animation techniques or visual effects. The process of filmmaking has developed into an art form and a large industry, which continues to provide entertainment to masses of people, especially during times of war or calamity.

Typical television or video programming provides a set programming schedule combining pre-set programming that is sequentially broadcast to a user via a particular channel. The user establishes what television programming, channel and the corresponding times that the programs are being broadcasted. The user is then able to select from among a set number of broadcast channels, programming and/or times for the video to choose from. As a result, the user relies on the taste of the broadcasting studio to provide interesting content, at available times and on available channels for viewing. If the content is not suitable, another broadcast channel is selected or the user can opt to find different television entertainment, such as a movie rental, paid programming, online streaming, and/or rely upon recording devices to store the video on a particular channel for later viewing. The above trends or deficiencies are merely intended to provide an overview of some conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for evaluating and communicating media content and/or media content portions corresponding to various media sources via a personalized video channel are described herein. An exemplary system comprises a memory that stores computer-executable components and a processor, communicatively coupled to the memory, which is configured to facilitate execution of the computer-executable components. The computer-executable components a source component configured to identify video content from a plurality of media sources comprising at least two of a wireless broadcast media channel, a web site, a web data feed, or a wired broadcast channel for communication via a personalized video channel. A demographic component is configured to classify a user device in a demographic class based on demographic data. A prediction component configured to generate a set of predicted video content from the video content of the plurality of media sources based on the demographic data. A streaming component is configured to communicate the set of predicted video content from the plurality of media sources to a mobile component via the personalized video channel and re-configure the personalized video channel to communicate, at different times, the video content identified from different media sources of the plurality of media sources.

In yet another non-limiting embodiment, an exemplary method comprises identifying, by a system comprising at least one processor, video content from a plurality of media sources for configuring a personalized video channel. The method comprises generating a set of demographic data related to a mobile device that is authorized to configure the personalized video channel with a first video content from a first media source of the plurality of media sources at a first time and a second video content from a second media source of the plurality of media sources at a second time. A set of predicted video content is generated from the video content of the plurality of media sources based on the set of demographic data. The set of predicted video content is streamed to the mobile device via the personalized video channel, such as in a wireless connection, for example.

In still another non-limiting embodiment, an exemplary tangible computer readable storage medium comprising computer executable instructions that, in response to execution, cause a computing system including at least one processor to perform operations. The operations comprise determining a set of demographic data related to a mobile device for configuring a personalized video channel in communication with the mobile device. A plurality of media sources is identified comprising at least two of a broadcast media channel, a web page, a web data feed, a network subscription service or a video library. The personalized video channel is configured based on the set of demographic data to communicate video content from the plurality of media sources at defined times.

The following description and the annexed drawings set forth in detail certain illustrative aspects of the disclosed subject matter. These aspects are indicative, however, of but a few of the various ways in which the principles of the various embodiments may be employed. The disclosed subject matter is intended to include all such aspects and their equivalents. Other advantages and distinctive features of the disclosed subject matter will become apparent from the following detailed description of the various embodiments when considered in conjunction with the drawings.

### BRIEF DESCRIPTION OF DRAWINGS

Non-limiting and non-exhaustive embodiments of the subject disclosure are described with reference to the following figures, wherein like reference numerals refer to like parts throughout the various views unless otherwise specified.

FIG. 1 illustrates an example system in accordance with various aspects described herein;

FIG. 2 illustrates another example system in accordance with various aspects described herein;

FIG. 3 illustrates another example system in accordance with various aspects described herein;

FIG. 4 illustrates another example system in accordance with various aspects described herein;

FIG. 5 illustrates another example system in accordance with various aspects described herein;

FIG. 6 illustrates another example system in accordance with various aspects described herein;

FIG. 7 illustrates another example system in accordance with various aspects described;

FIG. 8 illustrates an example prediction grid in accordance with various embodiments described;

FIG. 9 illustrates an example of a flow diagram showing an exemplary non-limiting implementation for a system in accordance with various aspects described herein;

FIG. 10 illustrates another example of a flow diagram showing an exemplary non-limiting implementation for a system in accordance with various aspects described herein;

FIG. 11 illustrates another example of a flow diagram showing an exemplary non-limiting implementation for a system in accordance with various aspects described herein;

FIG. 12 illustrates another example of a flow diagram showing an exemplary non-limiting implementation for a system in accordance with various aspects described herein;

FIG. 13 illustrates another example of a flow diagram showing an exemplary non-limiting implementation for a system in accordance with various aspects described herein;

FIG. 14 illustrates another example of a flow diagram showing an exemplary non-limiting implementation for a system in accordance with various aspects described herein;

FIG. 15 is a block diagram representing exemplary non-limiting networked environments in which various non-limiting embodiments described herein can be implemented; and

FIG. 16 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements. The word “set” is also intended to mean “one or more.”

### Overview

In consideration of the above-described trends or deficiencies among other things, various embodiments are provided that aggregate video content into a single personalized communication channel and/or into multiple personalized channels that are configured independently according to user profile data, a user's likes and dislikes for timing, content and/or source of content for each personalized channel. For example, video content can be obtained from one or more media sources such as social networks, news feeds, web page feeds, broadcast networks, internet subscription services, etc., and aggregated for viewing as a single communication channel via a user device or a display component of a user device based on user profile data. The system operates to personally configure personal channels independently according to a user profile data that comprises user preferences, tracked behavioral data corresponding to the respective channels and/or demographic data related for a client device, as well as predicted video content and respective media sources.

Embodiments herein describe a system and method for configuring a personalized video channel based on user profile data and/or demographic data from a “cold start.” User profile data, demographic data and demographic data is then further learned and aggregated throughout user interaction via a mobile device or other user device, in which the configuration of the personalized video channel dynamically alters the channel with video content and/or data from media sources for scheduled times, dates, and events.

The channel herein can be a software implementation of video streaming configurations, a wired channel, and/or a wireless signal channel that channels video content from multiple media sources via the same personalized channel to a client device. The term “cold start” is a system without user profile data that has been learned. A cold start of the system and methods can have data pertaining to a user, such as manual configurations form media content options, various media sources, and/or video content, as well as from demographics known. The demographics, the behavioral data and preferences are adapted or learning with respect to time, or over time and are adaptable by being modified, supplemented and/or deleted, regardless of whether initiated in the system at “cold start” or not. As such, the demographic data can be adapted to a user device based on movement, location, and/or geographic changes, such as when a new residence is taken up, a new audience, newly identified media sources, and the like for identifying video content and an updated set media sources being identified, for example, in which some could no longer be accessed, such as for lack of subscription renewal, available, or a number of reasons, as well as additional media sources being available.

In one embodiment, the demographic data ascertained based on the client device comprises a set of population statistics. Over time, the system operates to weight populations statistics for a region, geographic area, country and/or surround radius of a permanent residents of the user of the user device to a data obtained/retrieved/received about a user and the user's video content habits. After the system collects sufficient information about user habits, it would be able to make video content predictions.

Today, there are thousands of TV and radio stations to choose from. Embodiments herein implements dayparting of media sources and video content from among the media sources and further adapt to user profile data over time with demographic data. The demographic data and user profile data are weighted with an initial weighting measure for the demographic data being greater than user profile data. Dependent upon one or more of time, amount of user profile data ascertained, type of user profile data (e.g., preferences, options for scheduled times, user correlation data of the channel to particular media sources for particular date/times, genre preferences, etc.), and/or manual configuration of the weighting measures, the weighting measures dynamically alter to consider user profile data according to a different weight than initially set for the user profile data, and likewise for the demographic data. For example, at cold start or at initiation the demographic data could have weight measure(s) that are greater than the user profile data, and as time continues the user profile data could be weight more dynamically based on the system learning user profile data. However, in response to a client device of user taking up a different permanent residence, the demographic weighting measure could reset to have a weighting that is either stronger than where it was previously at a point in time, and/or revert to being stronger than the user profile data. Vacations are another example in which the weighting measures could dynamically change, but the weighting measures could be weighed differently from a response to a transition of a permanent resident status (e.g., an ascertainment of a user desire to remain in a location—bills being paid, new address change with online purchases, etc., and a physical location for a period of time or a predetermined duration). The weighting measures, for example, could be a percentage, a ratio, a decimal multiplier, a divisor, a rating from one to ten, or some other scale, such as a letter grade scale and/or the like.

### Demographic Prediction Channel

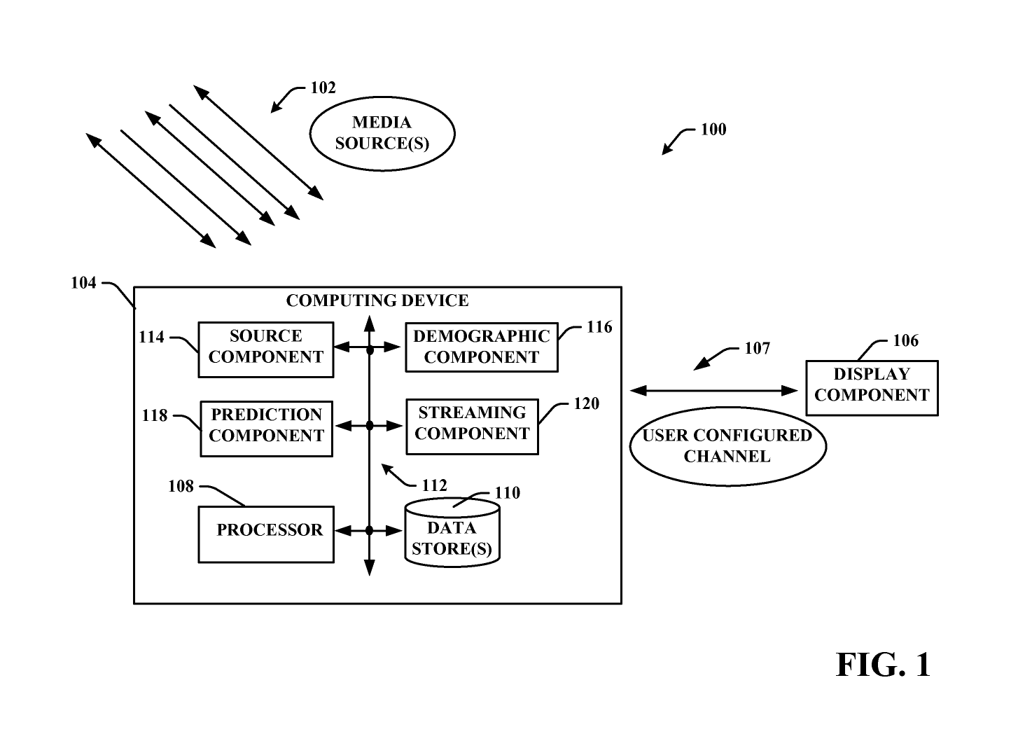

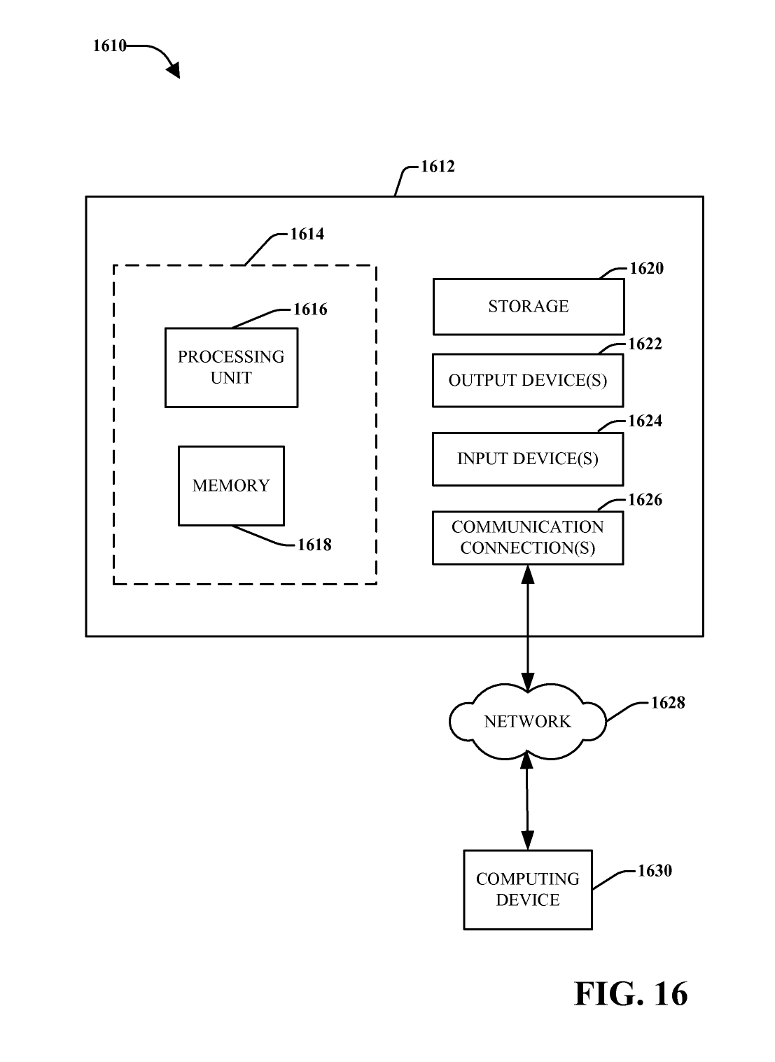

Referring to FIG. 1, illustrated is an example system 100 that generates a user configured video channel based on a user profile in accordance with various embodiments disclosed. System 100 can include a memory or data store(s) 110 that stores computer executable components and a processor 108 that executes computer executable components stored in the data store(s), examples of which can also be found with reference to other figures disclosed herein and throughout, such as the computer device 1612 of FIG. 16 and elsewhere. The system 100, for example, includes a computing device 104 that can include a mobile device, a smart phone, a laptop, personal digital assistant, personal computer, mobile phone, a hand held device, digital assistant and/or other similar device, which can include hardware and/or software communicating via a network, a wireless and/or wired transmission.

The computing device 104 operates to receive and aggregate multiple media sources 102 and corresponding content (e.g., news broadcast, television programming, web cast, web page feeds, personal data and other media content) into a single communication channel 107 to be rendered in a display component 106 for viewing by the user implementing the channel configurations and also by friends of other mobile devices that can interact for a community experience at scheduled broadcast times. The computing device 104 comprises various components that can operate and/or communicate via a network as the user configured video channel 107, wired and/or wireless communication channels, and the like. The computing device 104 comprises a source component 114, a demographic component 116, a prediction component 118, and a streaming component 120 that can operate synergistically to obtain media content (e.g., video content) from various media sources, aggregate the media content via the processor 108 and data store(s) 110 and dynamically communicate the media content in response to user profile data via a single channel 107.

The source component 114 is configured to obtain video content from a set of media sources. The source component 114 operates, for example, to identify video content from a plurality of media sources comprising a wireless broadcast media channel, a web page, a web feed, and/or a wired broadcast for communication via the personalized video channel 107, examples of which can include social network feeds, programming feeds, news feeds, local channel digital/analog broadcasting over air, cable broadcasting, internet content, video rental/subscription services on the internet, and the like. The source component 114 can be hardware (e.g., a processor), and/or software that searches networked communications, wireless communications via an antennae receiver/transceiver device, wired communications (e.g., optical, two-wire, etc.), local broadcasting, network web feeds, news feeds, web page content, data store(s), and the like. For example, the source component 114 is configured to dynamically identify broadcasted content from local broadcasting stations of locally aired programming, identify cable broadcast for paid/unpaid programming, TV-guide and/or other scheduling resources that publish scheduling or video content information as it is updated as metadata, a separate web page connection, and/or broadcast communication. The source component 114 further operates to identify and receive Rich Site Summary for new feeds of updated page content from social networks, channel pages, and/or subscribed services for video, as well as identify any other media source that communicates individual, studio produced, network uploaded, etc., video content for viewing at user defined preference times with user defined sources on a user controlled channel.

The demographic component 116 is configured to classify a user device in a demographic class based on demographic data. For example, a demographic class can comprise a set of data pertaining to the client device's location, physical address, duration within a geographical radius (e.g., more than fifty percent of time in an area code area, zip code, state, residence, and the like), a general broadcast area, cable provider region, in which this data can further include and be a part of the demographic data. The demographic data can further comprise population statistics such as viewing statistics for a viewing region, as defined by the demographic class, such as by area code, zip code, city/state boundaries, cable provider area, broadcast region, regional district, providence, political region, geographically defined region according to a geographic criteria, for example, an Appalachian region or the like.

Users often use client devices (mobile devices, etc.) such as the computer device 104 to search for appropriate/desirable video content for the given moment by scanning stations in search of what they might like or changing to a specific channel if they are looking for a particular content. In other words, typically, users are watching different channels at the different time moment and have to make special efforts for finding what they like or rely on channel manager to guess his tastes. The demographic component 116, for example, can comprise demographic information, and/or retrieve via a communication link, network, site, web feed, cloud network service, and the like a set of population viewing statistic data relative to the region as defined by the above criteria for the demographic class as the user device is identified to belong. For example, in the southeast region of Tennessee, a broadcast channel particular to outdoor activities, such as hunting, fishing, and trapping is broadcast in a particular area close to North Carolina. Viewing statistics indicate a greater likelihood of people in the East Tennessee area to watch fishing and in the North Carolina section to watch the hunting and trapping portions more due to a number of factors. This is an example of one viewing statistic. However, the demographic component 116 further factors dayparting information for viewing statistics, but conglomerates the data for a multiplicity of channels, broadcasts, locally, regionally, wirelessly, wired broadcast identified, web feeds, news feeds, social network feeds, personal data stores, site video subscriptions to one or more video rental/purchasing sites, channel webcasts, video distribution sites and the like.

Typical recommendation systems are not considering that user wishes to watch or hear one or another content based on the time of date. For example, if recommendation system knows user likes to watch thrillers, it does not mean that what user turns a television on in the morning, he wants to watch another film. Therefore, dayparting is enabled by the system 100 with the demographic component 116 to initiate the viewing based on sets of viewing population statistics, and/or per user demographics.

The system 100 is configured to operate as a predication system and to predict not only what each user via a user device likes to watch or listen to overall, but what he wants to watch or listen to at a particular weekday, daytime, around event date, i.e. Christmas, Wedding anniversary, etc. Thus, after the system 100 collects sufficient information about user habits, it would be able to make such predictions. But before sufficient information is available, there is a problem of cold start, which the demographic component 116 provides solution and further supplements the system throughout the user's employment. The same solution is serving the purpose of a starting point and a template to be adjusted towards each user individual timetable grid.

Initially, each user is assigned to demographic group based on known and guessed information. Later demographics are playing less important role in individual recommendations for each user, but it is still important to establish averages for forming recommendation for new users assigned to the same demographics group. Next, based on available open sources data, i.e., published TV listings, analytics/statistics of content popularity based on time-events, etc., an average timetable by genre is established based on user demographics. Next, all available content is filtered by genre. Each genre is associated with its appropriate daypart. As time goes by, system collects information of playback and rejections by each user including event timestamps and based on such data starts building individual recommendations based on content type and dayparts, in which dayparting herein is intended to refer to the practice of dividing a day into several parts for different programming depending upon the time, the day and the date. The result of the system is a dynamic personalized channel configuration that can include a personalized list of recommendations of content, which can be different for each user depending on the time of day, day of week, time of year, in conjunction with the video content and media sources identified. The system can operate, to a new user, relevant to the time of viewing of content by all users of the system, or, to an established user, relevant to time of viewing of content specific to that user based on the associated user profile data and demographic data.

Various video content sources can be identified via the source component 114 utilizing demographic data generated by a classification of the user device/display component 106 via the demographic component 116. The prediction component 118 is configured to generate a set of predicted video content from the plurality of media sources based on the classification and associated demographic data, as well as further user profile data as it is obtained. The video channel 107, for example, can be configured with predicted video content at times in which the channel is utilized for viewing, but where no defined media source and/or video content has been selected or configured for the scheduled time of the viewing.

For example, the user profile data could comprise information that a user of a mobile phone in primary control of the configuration of the channel 107 views reality shows (e.g., Pawn Stars, Swamp People, Gold Rush, etc.) at about or around the time the device is also scheduled for sleep mode, or shut off. In a situation where the user views his/her personalized channel 107, even though the channel is not configured for a certain date or time, the system could communicate learned likes and dislikes for the particular time and either communicate reality show options and/or select a best option by which to stream video content via the channel 107 to the user as predicted content for dynamic configuration of the personalized video channel. The system 100 thus learns dynamically and interacts to simplify and interactively enrich viewing experiences throughout the user's life with the mobile device 106.

The streaming component 120 is configured to communicate the video content from the plurality of media sources 102 to the display component 106 (e.g., a display panel, a display device—mobile smart device, personal computing device, personal digital assistance, mobile device, processor device, etc.) based on the demographic data and user profile data generated by the computing device 104. The streaming component 120 is further configured to communicate the video content from different media sources of a plurality of media sources at different times based on the user profile. Further, the streaming component 204 can operate to communicate different video content from different media sources at the same time at different personalized channels 107, and/or at the same channel for interacting with one type of content and viewing another, such as video chat with various client devices while viewing the video content from media sources at the same time.

In another embodiment, the computing device 104 operates to stream video content via the streaming component 120 from various media sources at prescheduled timing, dayparting, demographic data and based on the user profile data of the user's profile with video content, and media sources including at least two of a broadcast (wired/wireless), power line carrier signal, optical link, web feed, web link, a network, personal video library and the like. The user can set the content, times and media sources with user preferences and also have updated content dynamically provided as selections through the predicted content as well as recommended content. The computing device 104 can operate to recommend or suggest configurations (video content, scheduling, media source options) as selectable user viewing options based on the demographic data, including demographic viewing statistics (e.g., average preferences, most popular, outlier programming, alternative video broadcasts, and the like, together with statistics related to a local area network, a wide area network and/or other more global networks) and the user profile information as it is obtained and dynamically learned by the system 100.

In addition, a different mobile device or display component could access the channel 107 remotely to view what the user is viewing, or the same video content. The different additional display device/component to the display component 106 could also provide comment and/or interaction regarding the content via the channel 107, which is further discussed below.

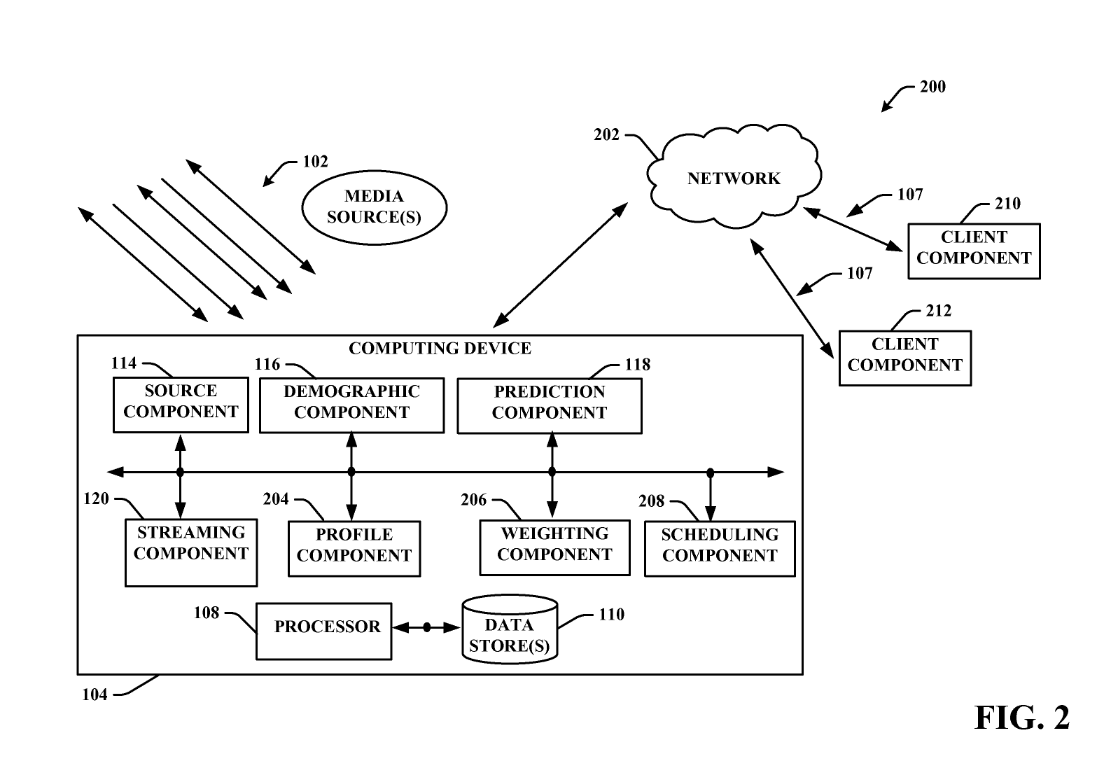

Referring to FIG. 2, illustrated is an example system 200 for generating personal media viewing in accordance with various embodiments described herein. The system 200 operates to obtain media content from media sources 102 such as from social networks, online news data feed, video services and other web pages/sites, and further aggregates the media sources into a personalized viewing channel 107 based on user profile data and predicted video content. The personalized viewing channel 107 operates as a configurable user video channel that can be configured by the computer device 104 to provide programming (e.g., video content, or other media content) as a series of personally scheduled content from various media sources that broadcast, post, feed update, upload, etc. programming for general viewing and/or subscribed viewing. The programming, video content, and/or media sources communicate via the personalized channel 107 can be configured based on user profile data identified by the client component 210, for example. The personalized video channel 107 can then operate to be subscribed to, viewed at certain times, and/or freely available to other client components 212 (e.g., mobile devices), in which the client component 210 can control via user profile data. The system 200 can operate to communicate via one or more communication lines, via a network 202 (e.g., cloud network, local area network, wide area network, and the like), a wired connection, and/or a wireless connection with similar components and further comprises a profile component 204, a weighting component 206, and a scheduling component 208.

The computing device 104 operates further to predict video content and associated media sources for a personalized video channel 107 to communicate based on user profile data. The prediction component 118 operates to analyze user profile data aggregated by the profile component 204 and to communicate video content via the personalized channel 107 based on the predicted content. For example, in situations where no scheduled viewing is configured to the personalized channel 107, the prediction component 118 can analyze, store, and communicate updated content via the personalized channel 107, which depends on the user profile data and/or demographic data for such predictions. The computer system

Various video content sources can be identified via the source component 114 utilizing a user profile (user profile data) generated by the profiling/profile component 204. The profiling component 204 is configured to generate user profile data based on a set of user preferences related to the video content and/or a set of behavioral data. The user profile data, for example, can be from a user profile of a user that is generated. The user profile data can include login information, a user name, user personal data, authentication data, media source preferences, media content preferences, time preferences for video content/media sources, date preferences for video content/media sources and/or the like user preferences. The user preferences can further include a time preference to associate with the media content or video content and other classification criteria, such as a personalized channel selection, a theme preference for types of media content (e.g., Science Fiction, Drama, etc.), a rating preference (e.g., G rated films, five start films, etc.), an actor preference, a language preference (e.g., Spanish, Russian, English, etc.) and/or a date preference (e.g., release date, viewing dates, broadcast dates) pertaining to the personalized channel 107 for configuring and/or identified media sources for content via the source component 114 at one or more user defined scheduled times. The user profile data configured by the profiling component can further include classification criteria that include at least one of a theme, an age range, a media content rating, an actor or actress, a title, and the like metadata for identifying content, communicating media sources identified, and/or identifying updated media content of a media source and/or particular broadcast/upload/data store/feed stream.

The prediction component 118 is configured to generate a set of predicted video content from the plurality of media sources based on the user profile data. In one embodiment, the video channel 107 can be configured with predicted video content at times in which the channel is utilized for viewing, but where no defined media source and/or video content has been selected or configured for the scheduled time of the viewing. For example, the user profile data could comprise information that a user of a mobile phone in primary control of the configuration of the channel 107 views reality shows (e.g., Pawn Stars, Swamp People, Gold Rush, etc.) at about or around the time the device is also scheduled for sleep mode, or shut off. In a situation where the user views his/her personalized channel 107, even though the channel is not configured for a certain date or time, the system could communicate learned likes and dislikes for the particular time and either communicate reality show options and/or select a best option by which to stream video content via the channel 107 to the user.

In one embodiment, the user profile (data) generated by the profiling component 204 further comprises behavioral data that includes search data, viewing data, purchasing data, communicated data, each relating to ways the user of the user profile has interacted with video content as well as other user input controls related to video content (e.g., storage, viewing times, fast forwarding, skipping, replaying, search terms, and other input controls as related to video content). For example, if evidence of Minoan civilization in Northeast Mich. (5000 B.C.) is searched, the computing device 104 utilizes the components therein to define various videos related to this search data to establish media sources having similar or related content and provide configurable options to the user for generating a personalized dynamic channel for viewing on the client component(s) 210, 212 at various times that could correspond with a newly broadcast programming, purchased programming, rented programming, web updated programming, subscription service programming, recorded programming stored and/or the like. For example, future viewing options can be communicated along with other metadata pertaining to the media content searched and the future viewing options can be programmed to view via the personalized channel 107 at the same time as the future scheduled viewing and/or stored for viewing at a another defined time. Therefore, a search engine (not shown) of the computing device 104 for video content of interest can be monitored or in communication with the profiling component 204 in order to dynamically present scheduling options, broadcast options, and/or media content/source options for a user to configure the channel 107. The search engine can be any search engine of a network (e.g., internet network) and/or a search engine provided in a browser of the computing device and/or client component(s) 210, and/or 212.

The user can select to view, configure, purchase, subscribe and communicate any one of these content options on the channel 107 to a client component 210 of the system 100 as well as to other mobile devices (e.g., client component 212) of subscribing friends to the user's configured channel. The criteria for presenting options to configure the channel 107 can be further limited based on the user preferences. Although a user is not intending to search for video content, the configurable personalized channel 107 and the computing device 104 can further operate in an operating background to ascertain user interest and user behavior along with set preferences to provide catered options for viewing when the user is ready to interact with video format or, in other words, operate television viewing for him/herself.

The behavioral data or user profile data can further include age data, household membership data and/or subscription data. The age data can comprise the age range of the user corresponding to the user profile, which can be used to ascertain a profile of age interest based on other population samples of similar age and/or generational preferences for dynamically interacting with the user for providing options to configure the personalized channel viewing experience. Household membership data can include other members of the user's household or immediate family, which can be used to configure other channels for their viewing as appropriate. The subscription data can be the various online or offline subscriptions that a user patronizes. For example, magazine subscriptions, cable subscriptions, video subscriptions (e.g., movie rental online or offline, such as internet subscriptions to streaming or by mail DVD content), video subscription sites, web feeds (e.g., social network news feeds), and the like can be identified and accessed as video content options and media sources for assigning to the channel 107 at defined times, for defined content, and the like. For example, if the user defined Friday night as watching one set of video content on the channel 107 from one media sources at a certain time, another video content from another media sources could be subsequently viewed automatically via the channel 107. The content can be set to be communicated via the channel 107 from various sources that offer different content. The content can be monitored for updated content, in which the user can be notified of and then select any number of options to configure the channel 107.

In addition, the behavioral data can include viewing information that rates a user's interest level in a video feed from one or more of the media sources. For example, the personalized viewing channel 107 can comprise a set of controls for operating the video content, in which the controls can be communicated to the display component 106. Based on the controls selected during viewing the computing device 104 can further ascertain user interest in the video content and make further recommendations of video content accordingly. For example, the controls can include directional controls, rewind, forward (to return to a previous segment or fast forward to a next one or a different program and/or a different media source), up and down (for changing different channels and/or different media sources, depending upon the personalized configuration of the channel).

The profiling component 204 further operates to aggregate profiles or log in access to a set of social networks, video subscription services online and/or other video distribution services and provides an access key for aggregating videos or media content via the source component 114. The user can connect his user profile to multiple services for video and provide the viewing over an assigned channel that is configured. Additionally, the profiling component 116 can import RSS subscriptions to the profile, in which the system 100 can operate to import video content, add video content, and updated content and information into the selected personalized channel 107.

In one embodiment, a client component 210 could set user profile data to transmit video content via the personalized video channel 107 according to a particular mood, a particular interest, a specific activity, a genre, a producing studio/company, an actor/actress, a language, a country/demographic, and the like preference or classification. The prediction component 118 analyzes sets of data that are assigned or associated to the personalized channel 107, in which various sets of data could be assigned to different personalized channels of one or more different client components of different users. As such, the user profile data is utilized by the prediction component 118 to predict viewing likes, dislikes, scheduling, media sources, particular video content, and the other video habits to program or configure the personalized channel 107 for viewing by the client component 210, which could be a source of the user profile data, and/or for multiple other client components 212 also. The computing device 104 further comprises a weighting component 206 and a scheduling component 208.

The weighting component 206 is configured to associate a first weight measure to the demographic data and a second weight measure associated to the user profile data. The weighting component 206 operates to modify the first weight measure and the second weight measure based on a predetermined threshold being satisfied, such as a particular amount of data, type of user profile data being received, defined period of time, defined amount of viewing times and/or generated via user selections, behavioral data learning, and/or demographic data. For example, the system operates as a recommendation system that continuously over time ascertains what each user via a user device corresponding to a configurable personalized video channel likes to watch or listen to overall, as well as what the user wants to watch or listen to at a particular weekday, daytime, around event date, i.e. Christmas, Wedding anniversary, etc. Thus, after a recommendation system collects sufficient information about user habits, it operates to generate predictions of video content from multiple media sources broadcasted, from social networks, web feeds, subscription service web sites, personal video libraries of user, social networks, news feeds, broadcasting websites, etc. for example that can be identified from one or more channels (e.g., over air broadcast, wired broadcast, network connection uploads, feeds, social network news feeds for particular friends, and the like. But before sufficient information is available, there is a problem of cold start, which is considered over a time frame. The same solution is serving the purpose of a starting point and a template to be adjusted towards each user individual timetable grid.

The data collection is an ongoing process, and thus the system continues improving predictions and recommendations for content, as user profile data (e.g., user preferences, behavioral data from user inputs to or for video content) and demographic data. The weighting measures can be a number, a percentage, a ratio, a decimal, an average, a rating measure such as a star or five stars, a grade such as an A to D for highly weighted to weakly weighted for consideration, a fulcrum or centroid could be provided for weighing the degree to which the demographic data is pertinent for predicted video content. In one example, a fuzzy logic, rule logic and/or other expert system algorithm for an artificial intelligence component (not shown) can be implemented and/or processed by the processor 108 and/or the weighting component operating as a specialized processor configured to weigh the demographic data obtained, as it is received and over time vary the weighing measure corresponding to the demographic data relative to a criteria for weighting the user profile data.

For example, the demographic data can be provided a greater than fifty percent weighting of the data used for identify video content and/or media sources from among that which is identified at a current given time. As time progresses, viewing habits of the mobile device are recognized for one or more times/dates, user profile data is gathered about the user choices, selections for content based on classification criteria (e.g., genre, titles, language, actors/actresses, time, search terms identification, purchases data gathered, audience viewing, etc.), the weighting component can alter the weight according to a centroid or other measure that moves the consideration of the demographics in general more towards personal profile information. The weighing component 206 is operable to be overridden by an override input, in which a manual configuration can ensure based on the user's designated wish. Although as new or updated video content/media sources are identified the system operates further in the background as if no override has occurred to present interactive options based on the user's taste as predicted at any point in time. In situations, times or dates in which no programming of a video content from a media sources is scheduled, the system can operate dynamically to provide “a best” or predicted option for play, in addition with other near relevant or predicted options.

For example, initially, each user is assigned to demographic group based on known and guessed information, in which the demographic component 116 ascertains statistical data and other factors for ascertaining the best likes/dislikes of an area population. Later or as time ensures for a certain period, amount of user profile data is collected, amount of viewing is identified and the pattern of viewing, as well as other criteria, user profile data, etc. is ascertained demographics can play a less important role, thus being weighed by the weighting measure differently in individual recommendations for each user, although the system would still provide some importance to establish averages, for example, for forming predictions for new users assigned to the same demographics group, in which the users can be other user devices that subscribe to the channel 107 and/or other user device's in communication with the computing device 104 configuring a different individualized or personalized video channel for viewing.

The scheduling component 208 is configured to generate a predetermined schedule of video content from the plurality of media sources via the personalized video channel 107 based on the user profile, including user preferences and/or behavioral data of the user's video viewing. The scheduling component 208 operates to manage scheduling operations and data from the media sources identified and extracted for video content. In one embodiment, the scheduling component 208 can aggregate data from the media sources 102 and/or other web pages in a data store as metadata. For example, the metadata can be provided from one of the media sources (e.g., CNN or other source) and/or be from a media source that does not have associated video content (e.g., tvguide.com), but provide associated programming data such as scheduling times, programming title, content information, other metadata, etc. associated with various programming of one or more of the media source content, in which programming can be a defined time of video content, content of a particular title, genre, and/or other classification of video content (e.g., a television or viewing guide web page).

In another embodiment, the scheduling component 208 controls timing aspects of the personalized channel 107 based on the user profile and associated data for the personalized channel 107. For example, a popular reality show from a web page and/or broadcast could be communicated via the personalized channel at a specific time and consecutively follow-up with a Facebook news feed of friends via the same channel. As such, content from different media sources can be scheduled at predetermined times that are different from the pre-scheduled programming times of the media source in which it originated or from updated times.

For example, video content from a first media source of a first time can be rendered to the display component at a user defined time and video content from a second media source at a second time can then follow and/or be scheduled for other times. This can enable the user to have dynamic video content from multiple different media sources at user defined scheduled times and interact dynamically via the user profile with updated content, viewing options and/or present newly participating or discovered media sources for video content to be communicated from as selections for being rendered, to be followed for updates and/or for portioning into partitions.

In another embodiment, the scheduling component 208 can operate to schedule portions of programming based on the user profile. For example, a certain topic of interest could be classified by the user preferences to predominate the selected personalized channel 107 at a particular time, such as content pertaining to a local disaster or pending disaster, as well as any other topic. Other aspects of the user profile can also be used as the portioning criteria, such as age category, audience rating, user interest, behavioral data representing user input controls related to video content (viewing, fast forwarding, skipping, purchasing, searching as search criteria, etc., as input actions. Segments or portions of subsets of videos or programming related to a local event can be extracted or spliced at transitions points (e.g., points between news stories within an hourly news broadcast or some other interval scheduled broadcast) to provide programming related only to the specific topic. The channel can be dynamic in real time, or, in other words, based on programming from media sources at the present time, and/or encompass programming that has already occurred within a certain defined time and has been recorded or stored in a data store. The programming recorded/stored can then be introduced among options for communication/viewing via the personalized channel 107 as user defined times rather than broadcast and/or updated times.

Additionally, the programming of scheduled video content and/or updated content can be performed via the channel 107 as selections by the user. New updated content from the plurality of media sources can be presented first while older content can follow in an order of relevance of a listing. The scheduling component 208 can then receive selection for one or more of these and scheduling options (e.g., times, dates, store, scrap, etc.) for rendering via the channel 107. For example, a user could desire to have history rendered via the channel 107 on Saturday nights with video content that is from other times and/or at the programmed times and then have a news feed from a different channel aired at a different previous time or in real time after the history programming. Times, dates and the channel 107 can be programmed based on the user profile data for any number of channels, media sources, video content, content options and/or portions of content to be rendered via the channel 107.

RSS feeds and/or feeds as discussed herein can comprises a group of web feed formats used to publish frequently updated works—such as blog entries, news headlines, audio, and video—in a standardized format. An RSS document (which is called a “feed”, “web feed”, or “channel”) includes full or summarized text, plus metadata such as publishing dates and authorship, which can be used to identify, communicate, obtain and/or render video content associated with the feed. RSS feeds or feeds, for example, can benefit publishers by enabling them to syndicate content automatically. For example, an XML file format allows the information to be published once and viewed by many different programs. They benefit readers who want to subscribe to timely updates from favorite websites or to aggregate feeds from many sites into one place.

RSS feeds can be read using software called an “RSS reader”, “feed reader”, or “aggregator”, which can be web-based, desktop-based, or mobile-device-based. The user subscribes to a feed by entering into the reader the feed's URI and/or by clicking a feed icon in a web browser that initiates the subscription process. In one embodiment, the source component 114 can at least partially operate as an RSS reader that checks the user's subscribed feeds regularly based on the profile data generated via the profiling component 116 for any updates that it finds, and provides a user interface to monitor and read the feeds. The computing system 104 further operates to identify and updated broadcasted data, subscription sites without RSS feeds, but that provide video rental, channel episodes/programming and the like based on a regular or periodic subscription service. The computing device 104 operates therefore to avoid manually inspecting all of the websites, channels, as well as social sites (e.g., Facebook, Twitter, etc.) and subscription services for download, such that new content is automatically checked for and advertised by their browsers as soon as it is available.

The streaming component 118 is thus operable to communicate a sequence of the video content from the plurality of media sources, as well as communicate various media content portions based on user profile data. For example, the streaming component 118 is configured to communicate an updated video content selection (e.g., a new episode, a new video from an identified friend on a social network, an updated of a social network news feed, a broadcast content programming at a certain time, title, or other related criteria data) as well as portions of each based on classification criteria and any partitions of the video content that is generated by the system 200. The display component such as a client component 210 is configured to receive the communicated content via the channel 107 and rendered the content to a display (e.g., a touch screen, panel display or the like) generate the updated video content associated with the updated video content selection in the display component via the personalized video channel in response to an updated video content selection input being received.

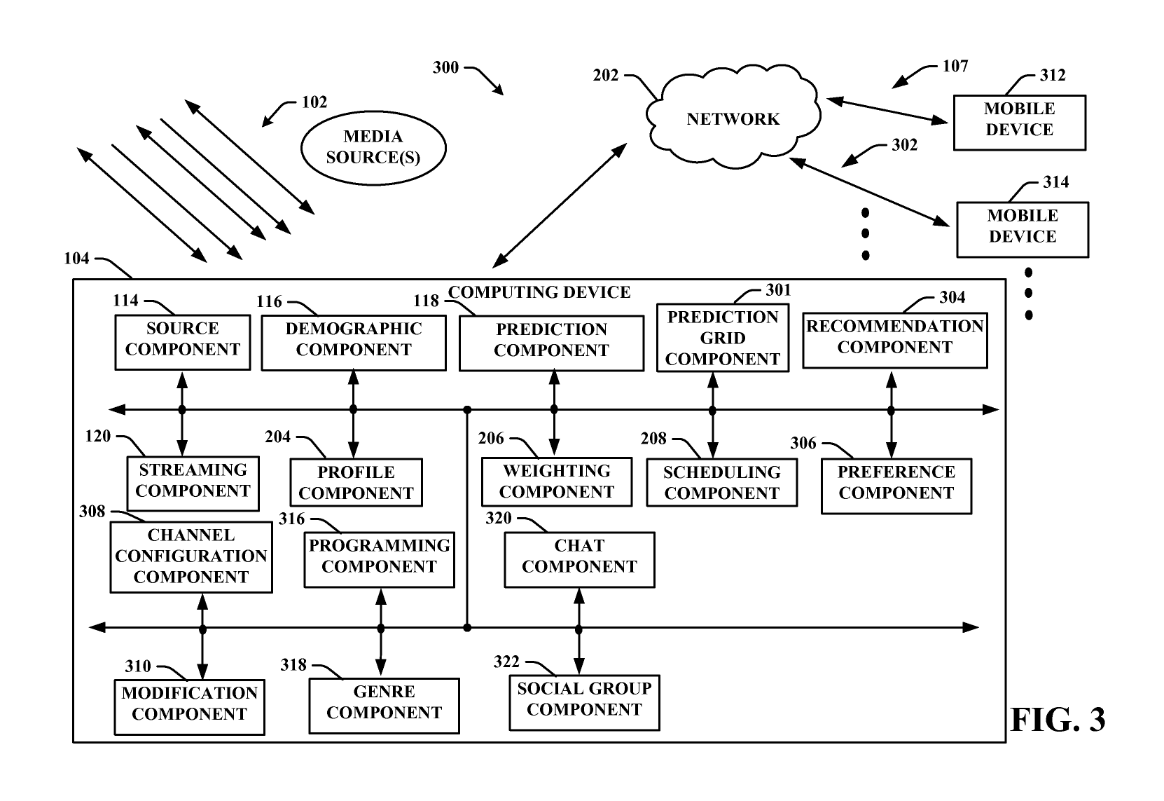

Referring now to FIG. 3, illustrates another example system 300 having similar components as discussed above to configure personalized channels from different media sources to one or more mobile devices. The system 300 continuously identifies media sources 102. The computing device 104 operates to add media source(s) to the media source(s) 102 and/or remove media source(s) from the identified media source(s) 102 as additional media source(s) are identified, become available, subscribed to and/or manually added/canceled by a user device or component (e.g., the mobile device 312 and/or 314). The computing device 104 can be further configured to associate different sets of media sources to respective mobile devices 312 and/or mobile device 314, and/or to different personalized video channels 107, and/or 302 based on user profile data communicated from the authorized user device/component (e.g., mobile device 312 and/or 314). For example, a personalized channel 302 communicated to a subscribing device to a particular channel 107/302, or mobile device 314, can be configured for viewing at defined times from an online video subscription services with particular video content and another channel 107 can at the same time be configured to communicate video content from a broadcasting local channel at a defined time to the mobile device 312. The mobile device 312 and the mobile device 314 can communicate to one another in a wired connection and/or wirelessly on the same wireless network or different network 202 as one another, which can include a Wide Area Network (WAN), Local Area Network (LAN), a cloud network and/or the like. The communication can be while viewing video content, controlled by one of the mobile devices as a the owner and authority for configuring the channel and/or as the manager of a particular channel, in which one subscribes to or request authorization without control to view or receive video content therefrom. The system 300 comprises the computing device 104 that further comprises a prediction grid component 301, a recommendation component 304, a preference component 306, a channel configuration component 308, a modification component 310, a programming component 316, a 318 genre component, a chat component 320 and a modification component 322.

The prediction grid component 301 is configured to communicate a prediction grid via the personalized video channel that includes different predicted video content of the set of predicted video content along a time line. The prediction grid comprises the time line that includes a past point of time, a present point of time and a future point of time that indicates corresponding predicted video content of the set of predicted video content at a selected point of the time line. For example, if a point to the left or right of the present point in time is selected, the prediction grid component 301 renders predicted video content from corresponding media sources for display. The predicted content from past or for future points in time can be one or more images representative of the various video content. For example, a Mickey Mouse cartoon could have been represented by a picture of Mickey Mouse. In addition or alternatively, an identification of the title and/or media source (e.g., Disney) providing the cartoon could be displayed for identification. Various groupings of the predicted content could be illustrated according to time, date, media source, video title, and the like. An input at a certain point in the time line can render a grouping of content, and/or the predicted content as an image.

In one embodiment of the predicted grid, the set of predicted video content corresponding to the past point of time, the present point of time and the future point of time are based respectively on the user profile data that is generated at the selected point of the time line. Therefore, predicted content for a certain time that lies within a past section (before a current point) of the time line could illustrate the content (or representation/image thereof) that would have been viewed had the client component or a user via the client component tuned into the channel 107 at that particular time/date.

In another embodiment, the set of predicted video content corresponding to the past point of time, the present point of time and the future point of time are based respectively on the user profile data generated currently in a user profile data store. Therefore, the points of the prediction grid would each represent video content and media sources based on the most recent up to date user profile data. Therefore, a user of a client component 210, 212 could view what would have been available and/or would be predicted and/or available at selected points based on the most recent user profile data, as well as content and sources identified for the particular time. In addition, a relevance axis or line can be generated to illustrate the relevance of the user profile data, in which the relevance can also be determined by a rank as well as a continuum along a relevance line to illustrate how relevant video content options are to the user profile data.

The recommendation component 304 is configured to recommend the video content based on the user profile, as well as recommend portions of video content and/or further media sources upon which to derive video content for communication via one or more personalized channels 107, 302. The recommendation component 304 can operate to communicate a set of recommended media content, media content portions (i.e., segments of media/video content) based on a set of classification criteria (matching audio content to search terms, theme, genre, audience category, language, location, actor/actress, personal video classification based on metadata, and the like) and/or user preferences of the user profile from the profiling component 116, which can include past viewed content. For example, the set of user preferences can include a selection of video content from media sources 102, in which the recommended media content portions of the selection of video content can be identified.

The recommendation component 304 operates to further narrow searching or identification of media content portions (e.g., segments of at least one of scheduled programming, video content, video feeds, social networking sites, video subscriptions services, and the like) within media content and video content (e.g., identified programming, movies, videos uploads, etc.) from the set of media sources 102. Because the volume of media content can be large from multiple different data stores/sources with different broadcasting channels, and/or web pages, the recommendations component 304 can further focus the generation of video content and associated portion to a subset of recommended video content (e.g., programming) and/or portions (e.g., segments of programming, such as news clips within a news broadcast), and provide options via mobile devices 312 and/or 314 to configure a personalized channel with other video content and/or media sources other than predicted content, and/or other prescheduled configured content/sources. In this way, various types of refined preferences can be used for various types of objectives as they are modified and/or entered into the user profile dynamically. For example, specific cultural significances, specialty significances, educational objectives, audience categories, language preferences, racial preferences, religious preferences, and the like can be used to generate portions of media from larger volumes of media content and from video content of various media sources, which can be defined in addition to other more standard preferences such as a theme (comedy, romance, drama, etc.). A user not satisfied with previously programmed content for the channel, either predicted and/or previously configured can search content via the network 202 in a search engine component (not shown) while being supplemented with recommendation options at the same time. Therefore, the user can be presented with recommended content as identified by the system from identified media sources 102 and also search results based on the search terms from the user's own search over particular/specified/other data stores.

The preference component 306 is configured to communicate preference selections received via the mobile device 312 and/or 314, such as via a graphical control and/or the like. The set of user preferences, as discussed above, can comprise at least one of a media source preference, a time preference to associate with the video content, a personalized channel selection, a theme preference, a rating preference, an actor preference, a language preference, a date preference, past viewing configurations and/or other preferences for media content and media sources. In one embodiment, the preference component 306 can provide options for preferences to a user via a personalized video channel (e.g., 107, 302) and to at least one of the mobile devices 312, and/or 314. The preferences can be received as selections for configuring the personalized channels at different times of a schedule and/or learned dynamically from user behavioral data that represents user control inputs related to video content and/or identified media sources 102.

The channel configuration component 308 is configured to modify the personalized video channel 107 and/or 302 to communicate the video content based on the predicted video content and/or on the set of user preferences of the user profile data. The channel configuration component 308 enables a plurality of channels to be configured and further communicate personalized video content from a plurality of media sources to one or more mobile devices 312, and/or 314. A set of user profile data can be assigned to the respective channels 107 and/or 302 independently so that the channels can be configured based on respective sets of user profile data (e.g., user preferences and/or behavioral data). For example, a channel 107 can be configured to communicate a first set of media sources with a first set of video content at different times and/or video content portions from at least two of the channels, and another channel 302 could be configured to communicate a second different set of video content and/or video content portions. Further, both channels 107 and/or 302 could be configured based on the same set of user profile data, in which the channel 107 can be configured from one set of media sources to communicate cartoons from a first broadcast station, and subsequently programming from another broadcast station, while the other channel 302 be configured to provide content from different media sources at the same time. Thus, the same user profile could enable a single household to access various programming configured to different channels from different mobile devices as well as access one or the other channel from the same mobile device, in situations where interest could change depending on a user's mood. In addition or alternatively, both channels 107 and/or 302 could be communicated to the same device 312 or 314, in which video content could be displayed alongside, in front of or behind the other video content streaming in different view panes.

The modification component 310 is configured to modify the video content, the plurality of media sources and/or a scheduled time for communicating the video content and/or media source(s) in response to a user input selection. The modification component 310 can modify one or more of the configuration channels and/or media source(s). For example, the modification component 310 can operate to change from one personalized channel 107 to another personalized channel 302 for a particular mobile device 312 for example. The channel 107 could be controlled via user profile data from the mobile device 312 and/or a different mobile device, such as mobile device 314, in which the mobile device 312 receives authorization to receive content via the personalized communication channel 107.

The modification component 310 can operate to alter content at a given time through a selection input or other input control received via a user device, such as mobile device 312 and/or 314. For example, a media source could be changed from a play list of options via a user selection. The modification component 310 can operate to control the prediction grid of the prediction grid component by modifying settings for display of the grid. For example, the prediction grid could show a history of predicted content for a particular time, whether past, present and/or future along the time line or time axis based on predicted content for the time. Alternatively or additionally, the modification component 310 can modify the basis for providing predicted content as dependent upon current recommendations in order to demonstrate viewing trends by which the system 300 can further predict viewing content at particular times, dates for various media sources and video content (programming) from the media sources.

Additionally or alternatively, the modification component 310 can modify the number or the amount of different video content that is provided to a mobile device 312 via the personalized channel 107. For example, a video could be communicated from a broadcast that is either being aired at a broadcast scheduled time, an additional chat screen could be generated for discussing video content, and/or video screen for video communicating with one or more other mobile devices at the same time. In addition, the number of screens for viewing content from different media sources could be modified in order to dynamically search for other video content and sources while viewing other video content and media sources.

The modification component 310 can also operate to configure a media source preference, a time preference to associate with the video content, a personalized channel selection, a theme preference, a rating preference, an actor preference, a language preference, a date preference, past viewing configurations and/or other preferences to the video content and media sources that the video content is derived from. For example, as a user continues to watch a particular series at a particular time, either broadcasted from a station as the source or streamed from an online site or feed, the system can alter a preference for the episodes/series/source to be associated with the particular times. The modification component 310 can dynamically interact with a user via the mobile device 312 for determining preferences, inquiring further about preferences at times, and/or modifying the set of behavioral data from user inputs related to different video content. For example, when an episode from a broadcast is not programmed at the usual time due to alternative programming, other predicted programming could replace it, while the system inquires further or indicates as such to the user for further override or input (via behavioral data and/or preference selections).

Based on available open sources data, and published listings, such as published TV listings, analytics statistics of content popularity based on time events, and/or metadata related to other video content, an average timetable by genre can be is established by a programming component 316 from demographics, and/or media sources that are able to be identified by the source component 114. The available video content and media sources can, for example, vary depending upon location, access, subscription services that a mobile device has access to, as well as web feed subscriptions, social networks, memberships to video content and the like over a network or other connection (e.g., satellite, optic cable, etc.). The programming component 316, for example, is configured to identify scheduling data corresponding to at least part of the video content from media information sources and further communicate external data from open sources and/or from metadata associated with any video content identified from media sources to the scheduling component 208 for generation of the programming schedule for configuring the personalized video channel, which is or can be considered the personalized channels configuration schedule for generation video content at associated times, dates, and corresponding media source therefor. The scheduling component 208, for example, is further configured to generate the programming schedule or play list that is further based at least partially on the scheduling data corresponding to the at least part of the video content from the programming component 316. The media information sources can comprise the plurality of media sources an additional media source that generates open source data for at least one wireless broadcast channel, the wired broadcast channel, and/or one of the media sources from which video content originates.

The genre component 318 can operate with the programming component 316 and other components of the system to generate classifications of the video content from the plurality of media sources based on a plurality of genres. The genre component 318 operates to identify the video content from media sources according to a classification, such as a genre. Other classifications could also be generated rather than just genre types and the associated video content related to the different genres, such as a time period (e.g., 1960's movies), an audience rating, late night/morning showing, documentary, reality, science, fiction, language, nationality, race, origin, and the like. The scheduling component 208 is further configured to generate the programming schedule further based on the classifications identified by the genre component 318 and according to a dayparting scheme, in which some times are provided with particular classifications of content. The genre component 318 can operate for dayparting with the scheduling component 208. The computing device 104 can configure a personalized video channel based on a dayparting scheme comprising a list of defined times for particular classification to be associated with the times/dates and therefore configure the personalized video channel with video content from media sources generating the particular associated classification. In addition or alternatively, particular video content selections from the different media sources could be designated and/or predicted to be shown by the system where no designation is made, or where a media sources is assigned, but not particular video content is designated.

As time goes by, system 300 operates to continuously collect information of playback and rejections by each user including event timestamps and based on such data starts building individual predictions via the prediction component 118 based on content type and dayparts. In one embodiment, predictions of content are made, which can include past, present and future predictions. The predicted video content can include current scheduled content configured based on the best or most relevant predicted content and other closely related content can be provided as future predicted content. In addition or alternatively, a personalized list of recommendations could also be provided or communicated via the personalized channel 107, for example. The end result of the system is a personalized list of recommendations of content different for each user depending on the time of day, day of week, time of year of using the system by the user. It is, to a new user, relevant to time of viewing of content by all users of the system or, to established user, relevant to time of viewing of content specific to that user.

The recommendations, for example, can be modified to save a current timestamps of a user action in the user activity history. This attribute will provide an opportunity to make a different user activity history in various time of day or week, and/or a different prediction grid, enabling different recommendations in different days or different time of the day. In addition to this, the content manager will be able to assign a few time-based specific attributes to the content in a data store or video content dayparting grid, such as “best in the morning”, “best in the day”, “best in the evening”, “best in the night”. Each content will have from zero to four these attributes associated with it. A recommendation component, discussed infra, can operate to consider these attributes of the content when all other attributes give uncertain result in the recommendation.

The chat component 320 is configured to communicate a chat screen via the personalized video channel to at least two mobile devices receiving the video content from the plurality of media sources via the personalized video channel. The chat screen from the chat component 320 can comprise a video chat screen for generating a video chat session, and/or a text dialogue that communicates via the personalized channel 107 and/or 302, for example, during, before and/or after viewing video content with one or more other mobile devices, such as with the mobile devices 312, and 314.

The social group component 322 is configured to receive a request from different mobile devices to communicate the video content from the plurality of media sources. For example, the mobile device 314 could communication request for joining, subscribing, accessing the personalized video channel that has been configured and controlled by the mobile device 312. The mobile device 312 could then provide an acceptance that is for particular times, full access and/or reject the requested based on the control of the configured channel being associated with the user profile (data) of the mobile device 312. In this manner, select groups of users and/or mobile devices can access configured personalized video channels at certain times to be interactive with personal videos regardless of location, and over a network 202, for example. While a video chat occurs, stored video can also be generate to recap events, such as a baby's first steps, a birthday, etc., while also viewing scheduled content at particular times from different media sources based on the configurations, user profile data, and demographic data of the controlling device, such as mobile device 312 for the personalized video channel 107.

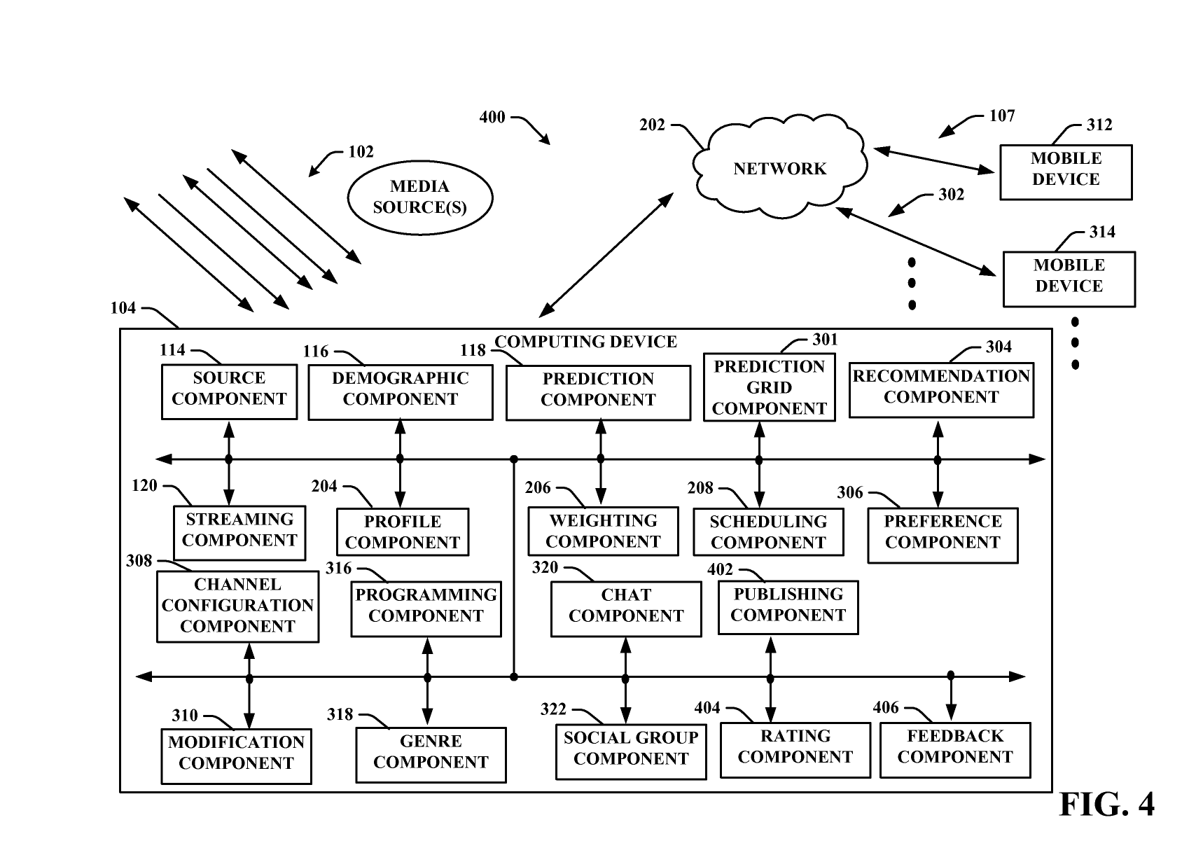

Referring to FIG. 4, illustrated is a system 400 for one or more personalized video channels in accordance with various embodiments described in this disclosure. The system 400 includes the computing device 104 with the components discussed above. The computing device 104 further includes a publishing component 402, a rating component 404, and a feedback component 406.

The computing device 104 is operable to publish components via the publishing component 402 to, from and/or via the network 202 for implementation of the operations of the computing device 104 at one or more client components or mobile devices. The publishing component 402 can further operate to publish personalized configuration channel(s) 107 for subscription to or viewing by other mobile devices other than the mobile device authorized for configuring the channel with various video content, scheduled times and media source(s).

The publishing component 402 can operate to control what mobile devices, networks, and/or web feeds are provided content via the personalized video channel 107, for example. The video content could be generated, for example, from a personal data store of family videos, as well as from various other broadcasting media, web pages, web feeds, and the like media sources. The video content could then be published to a social network for friends and family, and/or for one or more viewing devices for friends and family connected to the mobile device 312 via the network 202 for viewing content associated with the particular mobile device's user preferences. Videos of family, grandchildren, etc. could then be followed up with and/or subscribed to at various predetermined times. Consequently, grandparents could follow the growth of grandchildren and events published via the family personal channel before calling each week to their children, while also watching similar content via the same personalized channel for sake of conversation, or further interest.

In one embodiment, a user via the mobile device 312 is operable to configure the channel 302 as having a first set of video content from a first set of media sources (e.g., set of MTV videos, Facebook news feeds, chat/video conference screen, and the Grammy awards) and the communication channel 107 via a second different set of video content from different media sources by manually setting the content and/or managing the user profile data for settings, classifications/classification criteria, and/or behavioral data representing user input controls related to video input. The user profile data could be entered or learned to provide the Grammy awards via the personalized channel 302 at the same time as to mobile device 314 for viewing on, and thus, while FIG. 4 illustrates a different channel 302 is configured for viewing to the mobile device 314, the channel 302 could alternatively or additionally be shared to mobile device 312. The publishing component 402 is operable to publish a channel, such as the personalized channel 302 for any connected viewer from the same set of user profile data or from a different set of user profile data that has been enabled for access. For example, a request could be received by one viewer or one mobile device to another for accessing a personalized channel that is configured by the mobile device that is in control of personalizing or configuring the particular personalized channel. The publishing component 402 operates to communicate to the requesting mobile device the personalized channel (e.g., channel 107) upon acceptance of the request by the configuring mobile device (e.g., mobile device 312). One or more devices are able to access a personalized channel with personalized content and from a selected media source at any given time while also utilizing resources to share the personalized experience, such as with video chat, chat component, searching capabilities, suggestions, rating, personal content viewing, and/or personal commercial marketing intermittently with configured programming from different media sources and/or personal video content at the data store(s) 110.

In one example, the personalized channel 107 can be configured by the mobile device 312 for viewing at the mobile device 312 and also for the mobile device 314 with programming from one wired broadcast and of another wireless broadcast thereafter, and regardless of the different media sources and their sequential video content via the personal video channel 107, family videos in a data store of the mobile device 312 could be streamed intermittently, and/or other video content from a personal data base in communication with the mobile device 312. In another embodiment, control of the personalized channel and the configuration of the channel can be dynamic and be altered by the user profile data of the mobile device that is configuring the personal communication channel, such as with a password or other security. The mobile device 312 could alter the viewing of the Grammy Awards via the channel 107, therefore, to provide content from MTV videos playing different content, either at different times, intermittently, and/or at sequential times before and/or following the Grammy Awards. For example, while two devices 312, 314 are viewing the Grammy Awards, the mobile device 312 could alter the media source and/or viewing content to demonstrate, supplement, or change the main viewing to other video content. Both mobile devices could decide together that one type of video content is undesirable (e.g., boring) so a chat screen could be published via the publishing component 402 and utilized to indicate the desire to switch to another on the personalized channel 302. The mobile device in control of the configuration could opt to draw from an online video rental, other broadcast channel, a Facebook feed, etc., in which the two mobile devices would more enjoy with one another and on different mobile devices.

The rating component 404 is configured to receive a rating to associate with the video content or a media source, which the prediction component can utilize to further predict video content/media sources to communicate via one or more personalized video channels. For example, a mobile device 312 that receives predicted content via the personalized video channel 107 could provide a “like” or “dislike” to the particular video content/media source transmitted. The rating could also be a one to five star rating, a scaled rating on a measure of one to ten, or some other rating measure. The rating component 404 can store the rating for the prediction component 118 and/or recommendation components 304 to assess together with user profile data, comprising user preferences and user behavioral data learned, in order to provide increasingly more relevant video content recommendations and predicted scheduling content based on a user's taste and interest determined through the mobile device 312 and/or other data stores.

The feedback component 406 is configured to communicate a set of video content options that correspond to a modification of the user profile data, which could be generated via the modification component 310 and/or via modifications generated by receiving user input control/data. As modifications to the user profile data, preferences, behavioral data, etc. are made the feedback component 406 can operate to present, via the personalized video channel 107, different sets of video content from the set of video content recommended or provided as options to viewing from before. In addition, the predicted content for various times/media sources could also be altered, wherein the set of video content options comprise additions or deletions to at least one of the video content, the plurality of media sources, and/or a scheduled time for rendering the video content via the personalized video channel.

In one embodiment, the feedback component 406 operates to generate titles, screen shots, programming grids, different prediction grid points along a time line for the future events or scheduling that a user could choose according to the user profile data, including preferences, ratings, behavioral data, classification criteria/settings and the like. In this manner, the mobile device (e.g., 312, 314, etc.) can provide sets of user profile data associated with one or more personalized channels based on how the user profile data will alter dynamic video content and media source selecting, either as presented options, automatic scheduling, and/or for identifying new and updated video content/media sources of video content.

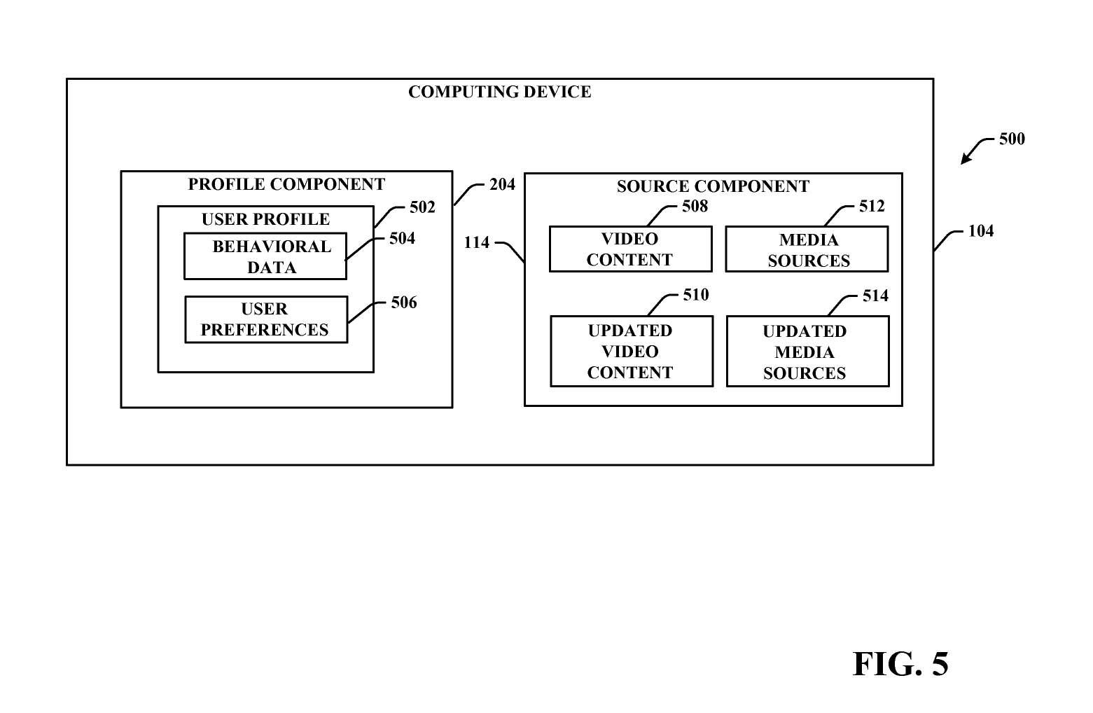

Referring now to FIG. 5, illustrated is an example system 500 in accordance with various embodiments disclosed. The system 500 includes the computing device 104 as discussed above with the source component 114 and the profile component 204 provided only for ease of discussion. The profile component 204 is communicatively coupled to a user profile 502 that comprises a set of behavioral data 504 that represents user input controls relating to the video content and the media sources, which are identified by the source component 114. The user profile 502 further comprises a set of user preferences 506.

In one embodiment, the set of behavioral data 504 comprises purchased video content related to the user profile data, viewed video content related to the user profile data, stored video content related to the user profile data, and/or search criteria for video content related to the user profile data. For example, a purchase of video content could be made with the computing device 104 or via a different device in communication with the computing device 104. The purchase can be stored as part of user profile data. The computing device 104 can utilize the purchase data along with other data learned in the user profile to recommend video content and/or media sources that are identified by the source component. The user can then opt to select a time slot, video content, and/or media source available through the recommendations provided. The personalized channel (e.g., channel 107, as discussed above) generated by the computing device can be configured with the times, content and source data according to the user's selection.

For example, a documentary on dinosaurs could be identified from a broadcast channel station (e.g., a public broadcast channel or the like) and the personalized channel be configured to transmit or communicate the documentary at the time that it is being broadcast. At the same time, a documentary similar to one that was purchased by the user could be configured to play after the dinosaur channel through a user selection of a selected content and/or media source as well. As mentioned above, the user preferences can also include viewed video content related to the user profile data, stored video content related to the user profile data, and/or search criteria for video content related to the user profile data, which can facilitate providing further recommendations, a past history record, as well as other information learned about the user's viewing habits, and/or for configuring/identifying further video content and media sources for a particular channel to be personalized at scheduled times/dates. The set of behavioral data can also include viewing data, search data, purchase data, location data, language data, age data, household membership data and/or subscription data.

In addition, the user preferences 506 can comprise a media source preference and/or a time/date preference to associate with the video content for viewing on a channel (e.g., channel 107) configured according to a user preferences and/or behavioral data related to video content. The user preferences 506 can further include a personalized channel selection where multiple channels are configured based on a user's personal preferences or classification criteria such as a theme preference, a rating preference, an actor preference, a language preference, a date preference and the like.

In one embodiment, the profile component 204 is further configured to receive a first user preference of the set of user preferences from selections related to the video content and identify a second user preference based on the set of behavioral data. For example, a personalized channel configured by the computing device for rendering different video content from different media sources at various times could recommend horror movies based on a theme preferences that a user has entered, as the user begins to override the preference and select different themes at a particular time or date, the system 500 could further recommend similar video content from differing media sources for viewing at the same time or on similar dates (e.g., weekly dates, etc.). Thus, a dynamic system 500 identifies, recommends and learns various user preferences and how they relate to one another in order to provide a dynamically configurable channel at the user's disposal.

In one embodiment, the computing device 104 is further configured to access at least one of the plurality of media sources based on the user profile data 502, such as when the user is subscribed to an online video rental site, a social network site that updates video content of friends associated with the user, as well as other web page feed services. For example, the user profile data can include access data to one or more web pages/sites, subscriptions services and/or other external video providers. This content can be presented to be configured into the personalized channel for viewing at pre-defined times or dates, as well as be used for recommendations based on other user profile data.

The source component 114 is further configured to identify updated video content 510 from among video content 508 that is different from the video content 508 previously accessed or identified as potential candidates for the personalized channel. This computer device 104 can thus communicate an updated video content selection of the updated video content 512 to the display component, and the display component is configured to generate the updated video content 510 associated with the updated video content selection in the display component via the personalized video channel in response to an updated video content selection input being received.

In addition or alternatively, the source component 114 can identified new or updated media sources 514, which could be identified from a more detailed search for media sources by the source component 114, a new broadcast or web page/site, a new subscription accessed/identified by the user profile data, and/or newly stored content in a data store or video library. A user selection could also be received for streaming via the personalized channel at particular times or dates that relates to which media source 512 or update media source 514 to render in a display or mobile device.

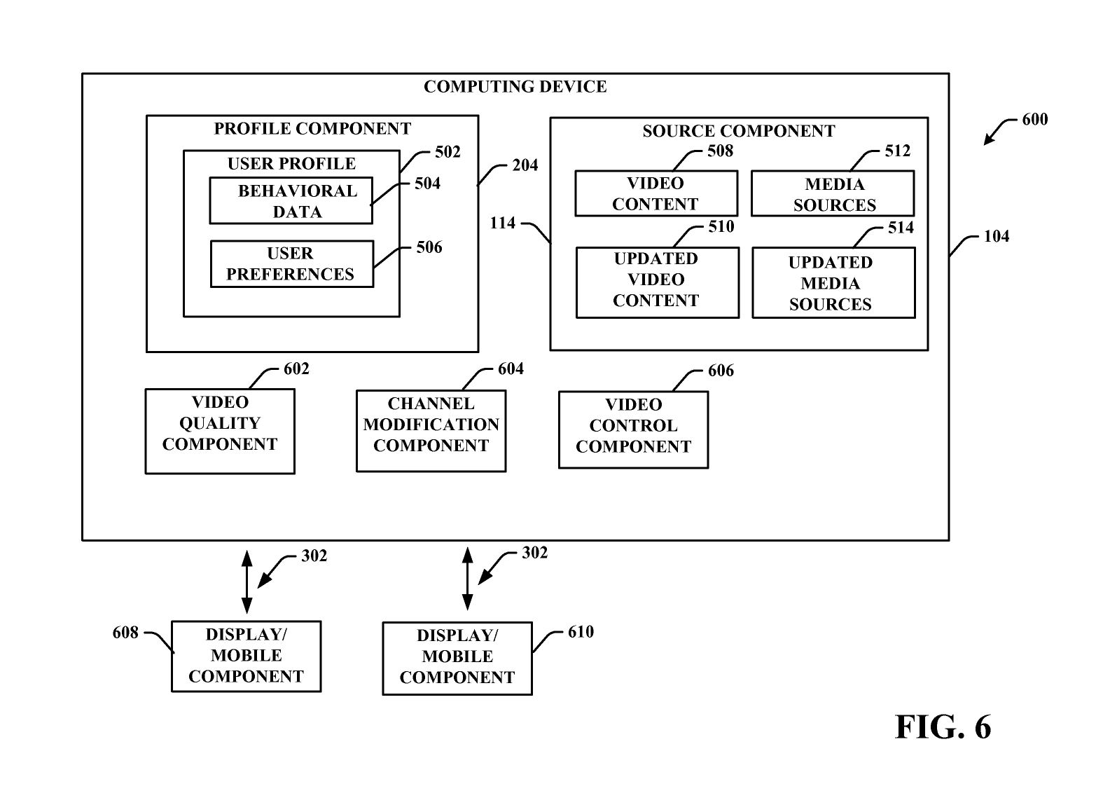

Referring to FIG. 6, illustrated is an example of a system 600 in accordance with various embodiments described herein. The computing device 104 comprises components detailed above and further comprises a video quality component 602, a channel modification component 604, and a video control component 606.

The video quality component 602, for example, is configured to analyze the video content 508 and/or 510 from the media sources 512, 514 to determine a set of video characteristics comprising at least one of bitrate, frame rate, frame size, audio content, formatting, a title, an actor or actress, or metadata pertaining to the video content. The channel modification component 604 can operate in conjunction with the video quality component to configure the quality of a personalized channel. The system 600 can operate to compare duplicate video content and eliminate the duplicates that do not satisfy a predetermined threshold for quality, and thus, leave only the video content among the duplicated video content with the highest quality metrics or that is of a greater quality of service based on one of the set of video characteristics.

The channel modification component 604 is further operable to change channels that are personalized from a first personalized channel that is based on one set of user profile data and to another personalized channel that is based on another set of user profile data. In one example, the channel modification component 604 can comprise a channel control as part of the channel control component 606. The channel control component 606 can operate to alter the video content from the media sources by generating a forward, rewind, pause, skip and other graphical controls for affecting video content generated on a single personalized channel, such as channel 302. The channel control component 606 can operate to change personalized channels, which each can be configured according to a different set of user profile data 502 or a different set of user preferences 506. In addition, the video control component 606 can generate selections for altering a media source and/or a video content to be streamed over the single personalized channel 302.

In another embodiment, the video control component 606 can operate to control subscriptions to a personalized channel, such as the personalized channel 302. For example, the display component or mobile device 608 comprising a display component can facilitate the configuration data for a personalized channel 302. The display component or mobile device 608 can thus subscribe in a request to the channel 302 that is personalized by the user profile data 502 from display component 610. Therefore, two mobile devices 608, 610 can view the same content at the same time together, and/or separate at different times. In one example, selections can be received via the display component of mobile device 610 for configuring the personalized video channel for the display of mobile device 608. The selections can facilitate rendering of the video content from the media sources by receiving at least two selections, such as a video content selection, a media source selection, a topic selection, a duration selection, a title selection, a language selection, and/or a video play list/selection, a date selection, or a recommendation selection.

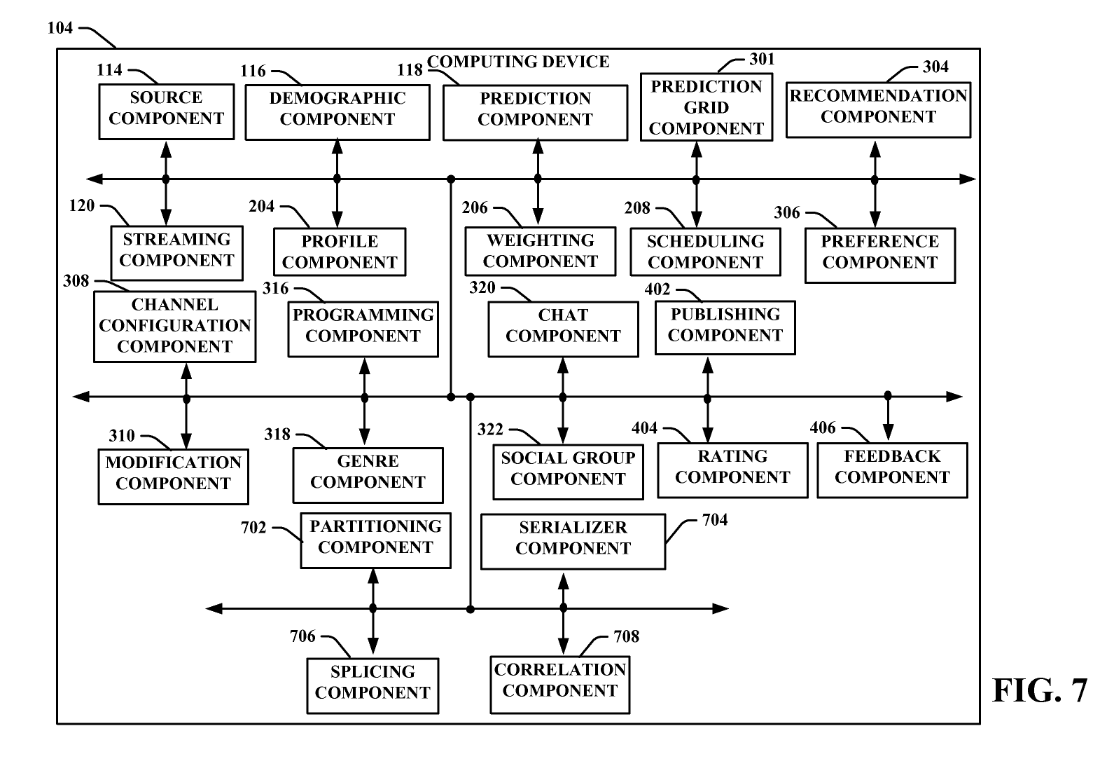

Referring now to FIG. 7, illustrated is another example system 700 for communicating predicted video content aggregated from media sources via a single personalized video channel in accordance with various embodiments described. The computer device 104 further comprises a partitioning component 702, a serializer component 704, a splicing component 706 and a correlation component 708.

The partitioning component 702 is configured to partition the video content from the plurality of media sources based on the user profile data (user preferences and/or behavioral data that represents user actions relating to video content). The partitioning component 702 operates to partition the video content of one or more media sources 102 into a plurality of video content portions (segmented partitions of programming, of videos uploaded on a web page, or of other video content) based on a defined set of criteria (e.g., the classification criteria) that comprises at least one of a topic, an audio content, a transition point in the video content, a duration or time frame, a match of the set of user preferences of the user profile data or the audio content of the video content being determined to match a word or phrase of a search term/criterion or terms/criteria of the defined set of criteria. The classification criteria can be part of the user profile data such as part of user preferences as a category for video classification preferences.

In one embodiment, the partitioning component 702 operates to partition video content into segments or subsets of the programmed content based on criteria defined as part of the user profile data. The portions or segments can be part of a video content as defined by a time frame, an end time, a title, and/or other defining or classifying criteria. For example, a portion of video content can be a section, segment or portion of a news broadcast, in which a certain topic could be discussed relating to a hurricane in New Orleans, while the entire news broadcast could be a designated hour long having multiple different segments related to different news topics or stories.

The streaming component 120 is thus operable to communicate a sequence of the video content from the plurality of media sources, as well as communicate various media content portions based on user profile data and from different media sources at different times. For example, the streaming component 120 is configured to communicate an updated video content selection (e.g., a new episode, a new video from an identified friend on a social network, an updated of a social network news feed, a broadcast content programming at a certain time, title, or other related criteria data) as well as portions of each based on classification criteria and the partitions generated from the partitioning component 702. The personalized video channel 107 can be configured to render the content to a display (e.g., a touch screen panel display or the like) and generate the updated video content associated with the updated video content selection in the display component in response to an updated video content selection input being received.

The serializer component 704 is configured to concatenate the video content from the plurality of media sources into a set of video content sequences, such as a sequence of scheduled programs, video uploads, new feeds, and/or video content portions of programs/uploads/feeds. For example, the set of video content sequences can comprise a portion of the video content identified from a media source based on the user profile data, as well as other video content from other media sources. Programming can be scheduled from scheduled content as published by the media sources and/or dynamically generated based on video content identified from the plurality of media sources based on the user profile data, such as with a video update on a social network, newly added downloadable content from a video rental site, video subscription service or other web page/site.

The splicing component 706 is configured to identify a portion or segment of a programming within the video content of a corresponding media source and extract the portion of the programming based on user profile data. The splicing component 706 can operate as a separate component from the partitioning component 702 and/or as a complimentary component of the partitioning component 702. While the splicing component 706 can operate to generate portions of video content segments or subsets of defined sets of video content, the partitioning component 702 can operate to generate the video content segments, or, otherwise known as, video content (video(s)) from different media sources. Some media sources, for example, such as a social network site could provide data indicating that a video upload or updated video content has occurred for one or more friends within a user's network. These videos could corresponding to different full length videos, which could range from a few minutes to hours, or more in duration, but have a defined beginning and ending point. However, broadcast television programming could have continuous video streaming that could be recorded and communicated via the personalized video channels 302 and/or 107, and/or communicated at the time of broadcast. The partitioning component 702 can operate to divide the different programming and video content identified among various channels, such as channel 302 and 107 based on user profile data, and/or divide broadcast programming to different channels as well as for different times, in which programming from one local broadcast could be streamed and then another local broadcast of a different station could be streamed thereafter without the user having to change a channel as in traditional methods.

The splicing component 706 can generate portions of segmented video content or of full length content that is not continuously broadcasted. For example, a new station could report, broadcast and/or upload a news hour broadcast. The different portions or stories could be dynamically spliced based on user profile data, such as search data. The portions can be presented to the user dynamically as options and then played to the client component 304 and/or 308 based on the user profile data and/or selections to the options.

The correlation component 708 is configured to correspond or correlate the set of predicted video content from the prediction component 118 to the prediction grid generated by the prediction grid component 301 a set of points in time along a time axis based on metadata associated with the video content (e.g., title, genre, location, producer, media source, etc.) and identification of the media sources of the set of predicted video content for a selected point of the set of points. The prediction grid further includes the different predicted video content along the time line and a relevance line based on a correlation measure of the different predicted video content to the user profile data. For example, where multiple options could have been presented in a prediction grid for a particular point in time based on the user profile data that is either current, or particular to the selected point in time, various options could have been generated as being closer to the user profile data than others. One content could have been recommended thus with a higher relevance or rank to the user profile data than another, in which the correlation component 708 can operate to determine the relevance and/or the rank. The predicted video content can thus be corresponded to a set of points in time along a time axis based on metadata associated with the video content and identification of the media sources of the set of predicted video content for a selected point of the set of points.

In one embodiment, the prediction grid component 301 can operate to generate future predicted content along the prediction grid. For example, a user can identify what could be available, predicted for viewing, and/or recommended at future times also. The future content could be based on programming scheduled already obtained, past programming schedules, available or identified media sources, and/or comprise a part of the predicted content that has a lower correlation measure from the correlation component 708 than another part of the broadcast, feed, upload, etc. Therefore, for example, at least a first part of predicted video content could be programmed as a future candidate that has a lower correlation measure than at least a second part of the different predicted video content, which is being predicted for current viewing or is currently being scheduled for viewing.

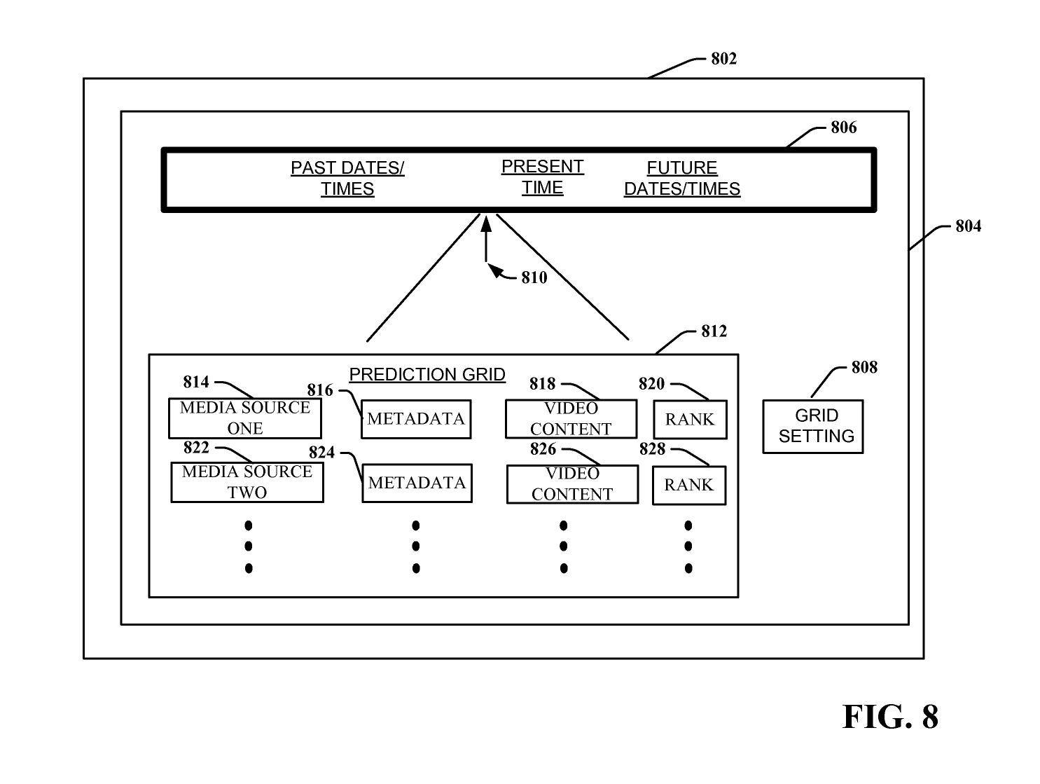

Referring now to FIG. 8, illustrated is an example prediction grid in accordance with various embodiments described. A personalized video channel 802 can comprise an address, link, broadcast, feed, video stream site, and/or the like for communicating personalized content from media sources identified from a wide array of sources, such as over the air medium, network sites, cloud configured resources, and/or the like. The channel 802 renders a view pane 804 with one example of a prediction grid 812. The prediction grid 812 can include or have separately in functional communication therewith a user interface time axis/line 806, for example, in which an arrow 810 and/or other pointer or control can be slide along a time axis 806. The time axis can also be considered the grid that has a time continuum of points relevant to user profile data for any one particular point of time (e.g., past dates/times, present time, future dates/times).

The example FIG. 8 illustrates the indicator arrow at a past date/time just past the present current time. From this selection emanates the prediction grid 812 results that were predicted by the prediction component, or would have been predicted based on the identified media sources for that point in time and/or the video content available, as well as user profile data that includes classifications for video content, user preferences as discussed herein, and behavioral data that represents user inputs received or learned by the system (e.g., types of video content viewed, video content purchases, looked over or not chose, etc.).

The prediction grid 812 data illustrated can comprise a set of media sources 814, 822 (e.g., media source one, media source two, etc.) with corresponding metadata 816, 824 (e.g., titles, duration, producer, date, portions spliced from based on search, manually added data, etc.) with a portion of or the video content 818, 826 and an associated relevance score or rank 820, 828, for example. In one embodiment, the video content that is predicted as an option, but not scheduled can be provided in a future time slot and along future dates depending upon availability at those times and dates, identified programming/video content, available scheduling already ascertained, etc. Video content that corresponds to the user profile data more closely can be automatically scheduled at times based on the user profile data (e.g., time learned in which the user is viewing reality shows, and/or in video communication, etc.), while other predicted content not correlating as closely, but could be of future interest to the user could be predicted on the grid time axis 806. In addition, video content already scheduled could be predicted if known to be updated and scheduled, such as regular episodes or other broadcast, web feeds of video content.

The view pane 804 can further generate a grid setting 808 that operates to determine the kind of predicted content viewed. For example, video content residing in the past could be reconfigured at each point based on current user profile data, or be based on the user profile data at that particular point in time that was available to operate similarly to a prediction/recommendation history for user to re-access or further research. The future content can be based on trend statistics or trend data, in which the user of the mobile device could be trending on watching a certain video content at particular times and as such the same trend could likely be continued and predicted based on upon certain trending criteria, such as frequency, scheduled times, availability, known programming schedules and the like.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases. Reference may be made to the figures described above for ease of description. However, the methods are not limited to any particular embodiment or example provided within this disclosure and can be applied to any of the systems disclosed herein.

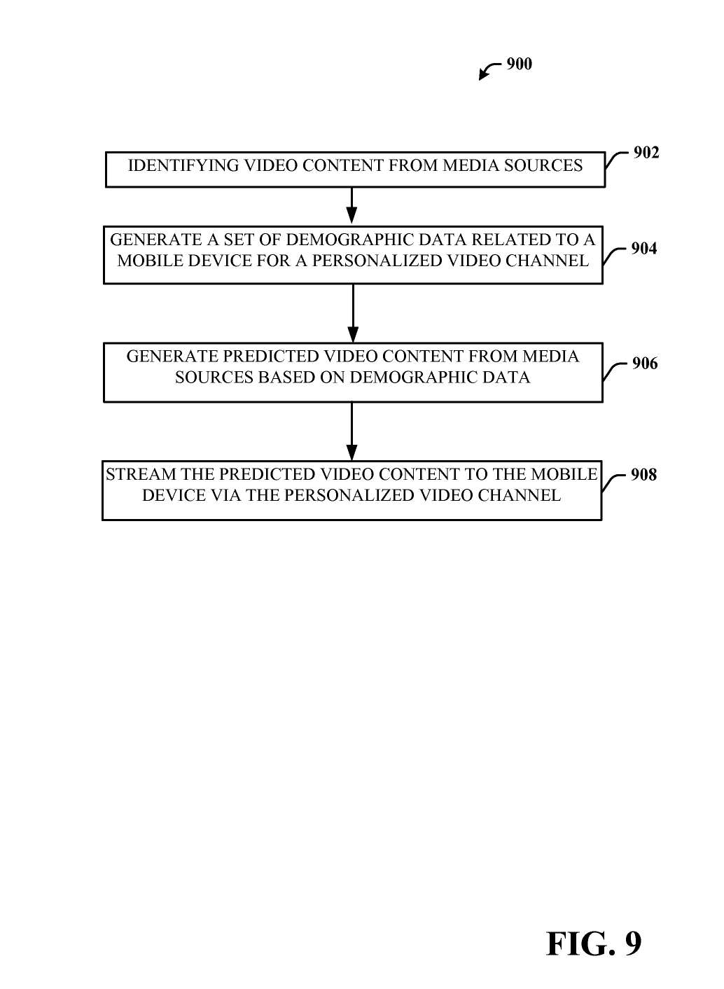

Referring to FIG. 9, illustrated is an exemplary system flow 900 in accordance with embodiments described in this disclosure. The method 900 initiates at 902 with identifying, by a system comprising at least one processor, video content from a plurality of media sources for configuring a personalized video channel. At 904, a set of demographic data is generated that is related to a mobile device that is authorized to configure the personalized video channel with a first video content from a first media source of the plurality of media sources at a first time and a second video content from a second media source of the plurality of media sources at a second time. At 906, a set of predicted video content is generated from the video content of the plurality of media sources based on the set of demographic data. At 908, the set of predicted video content is streamed in a video stream to the mobile device via the personalized video channel. The media sources, for example, can comprise at least two of a broadcast media channel, a web page, a web data feed, a network subscription service or a video library, and the set of demographic data comprises a geographical location including a political region, a time, a date, and statistical data of viewing preferences related to at least one of the geographical location, the time or the date.

The method 900 can further comprises associating a weighting measure to the set of demographic data and to the user profile data respectively. In one example, the weighting measure can be modified based on an amount of user profile data generated. In addition, a programming schedule is generated for the set of predicted video content based on the set of demographic data that comprises statistical data of viewing preferences related to at least one of a geographical location, a time and/or a date.

In one embodiment, a chat screen is communicated via the personalized video channel to at least two mobile devices receiving the video content from the plurality of media sources via the personalized video channel. Additionally, the personalized video channel can be configured to communicate the video content from the plurality of media sources at defined times based on user profile data that includes a set of user preferences and a set of behavioral data. The set of user preferences can comprise least one of a media source preference, a time preference to associate with the video content, a personalized channel selection, a theme preference, a rating preference, an actor preference, a language preference and/or a date preference. The set of behavioral data can comprise at least one of purchasing date, viewing data, search data, purchase data, location data, language data, age data, household membership data and/or subscription data, and at least one user input control related to the set of predicted video content being communicated via the personalized video channel.

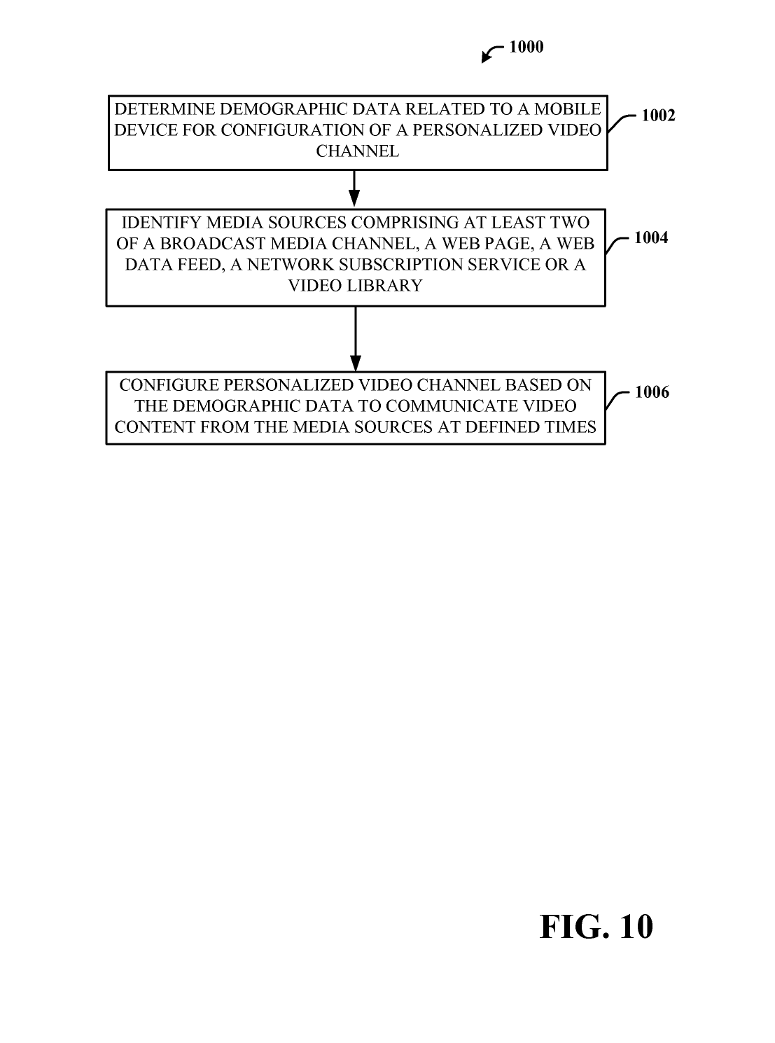

Referring to FIG. 10, illustrated is an exemplary system flow 1000 in accordance with embodiments described in this disclosure. The method 1000 initiates at 1002 with determining a set of demographic data related to a mobile device for configuring a personalized video channel in communication with the mobile device. At 1004, a plurality of media sources are identified that comprising at least two of a broadcast media channel, a web page, a web data feed, a network subscription service or a video library. At 1006, the personalized video channel is configured for viewing based on the set of demographic data to communicate video content from the plurality of media sources at defined times. The set of demographic data can comprise, for example, a geographical location including a political region, a time, a date, and statistical data of viewing preferences related to at least one of the geographical location, the time or the date.

The user profile data can be determined based on a set of user preferences related to the video content and a set of behavioral data representing user control inputs related to the video content. The personalized video channel can further be re-configured based on the user profile data to communicate the video content of a different media source for a defined time of the defined times. A chat screen is generated to at least two mobile devices receiving the video content from the plurality of media sources via the personalized video channel. A genre classification to the video content from the plurality of media sources can be made, wherein the configuring the personalized video channel is based on the genre classification of the video content for the defined times.

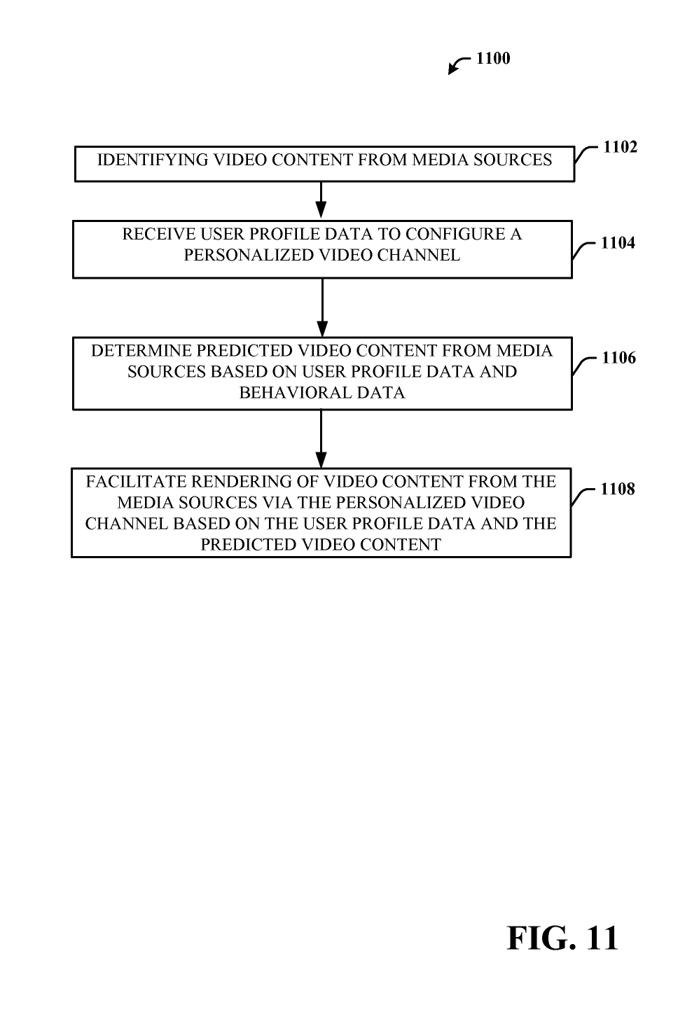

Referring to FIG. 11, illustrated is an exemplary system flow 1100 in accordance with embodiments described in this disclosure. The method 1100 initiates at 1102 with identifying, by a system comprising at least one processor, video content from media sources for communication of the video content via a personalized video channel. At 1104, user profile data is received or determined to configure the personalized video channel according to a time, the video content and the media sources of the video content. At 1106, a set of predicted video content is determined from the media sources based on user profile data that comprises user preferences and a set of behavioral data representing user control inputs received for the video content. At 1108, a rendering of the video content is from the media sources is facilitated via the personalized video channel in a display component based on the user profile data and the set of predicted video content, such as a selection for the predicted content from the prediction component and/or a user input control selection from among options presented.

The media sources can comprise at least two of a broadcast media channel, a web page, a web data feed, a network subscription service or a video library with personalized video content, such as home/personal videos with a recording device. The personalized video channel is able to be modified by a user with a second video content from a second media source to replace a first video content from a first media source at a designated or scheduled times. For example, the user preferences can comprises a time preference, a date preference, a video content preference, a media source preference or a video portion preference that corresponds to the video content from the media sources.

In one embodiment, the method can include receiving a request from a first mobile device to receive the personalized video channel at the first mobile device. The second mobile device that can be authorized to configure the personalized video channel for different media sources and/or video content identified can generate an acceptance for the first second mobile device. The system can then receive the acceptance and publish the personalized video channel to the first mobile device.

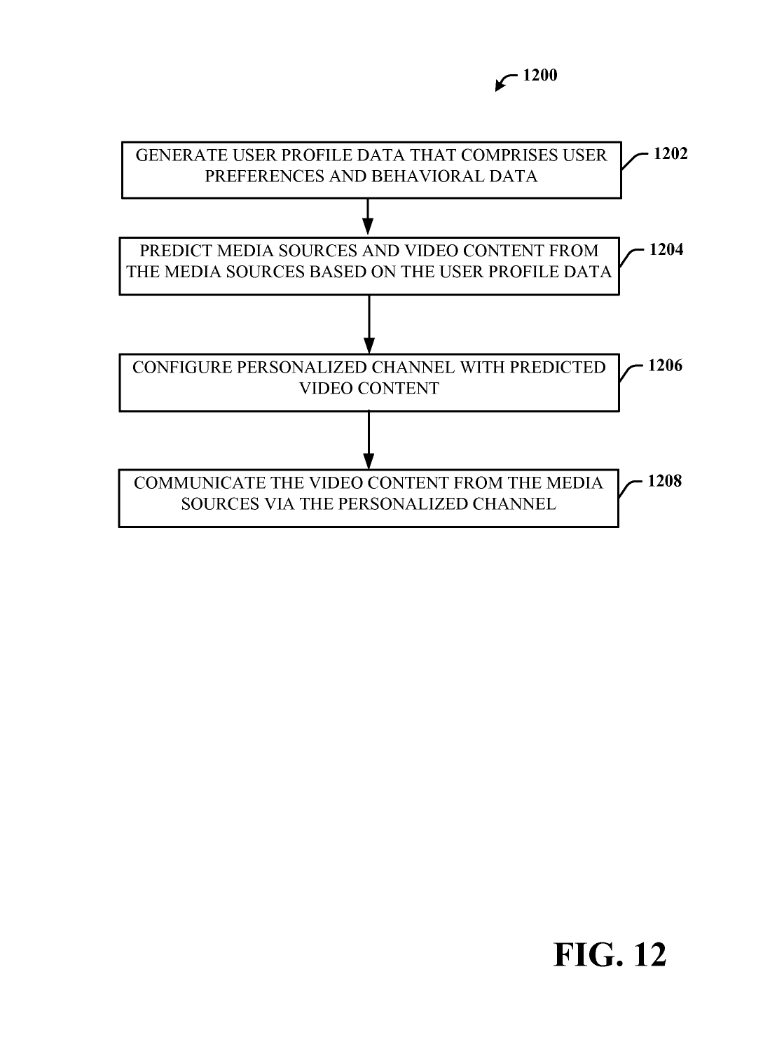

Referring to FIG. 12, illustrated is an exemplary system flow 1200 in accordance with embodiments described in this disclosure. The method 1200 initiates at 1202 and generates user profile data comprising user preferences and behavioral data representing user control inputs associated with a personalized channel to be rendered by a mobile device. At 1204, media sources and video content communicated from the media sources are predicted based on the user profile data for a viewer or a user of the mobile device. At 1206, the personalized channel is configured with the predicted video content from the media sources at different times based on the user profile data and the predicted media sources. At 1208, the video content is communicated from the media sources via the personalized channel for rendering by the mobile device.

In one embodiment, the method 1200 can further comprise generating a prediction grid that communicates the video content based on the user profile data. The video content predicted is corresponded or associated to a set of points in time along a time line based on metadata associated with the video content and identification of the media sources of the video content for a selected point of the set of points. A prediction grid can also be communicated via the personalized channel to the mobile device, in which the prediction grid comprises a past point of time, a present point of time and a future point of time of the set of points that indicates the video content predicted at the selected point depending on a set of criteria that comprises at least one of user profile data stored at the present point of time, or user profile data stored at the selected point along the time line. The user preferences can further include a classification criterion that comprises at least one of a theme, an age range, a media content rating, an actor or actress, or a title, represented in the user profile data.

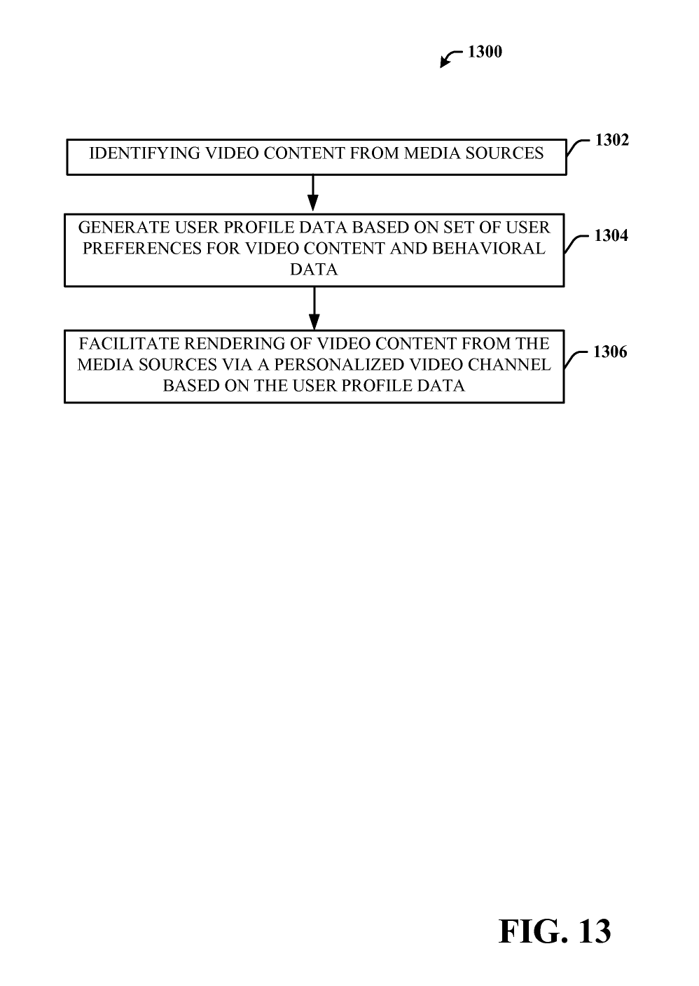

Referring to FIG. 13, illustrated is an exemplary system flow 1300 in accordance with embodiments described in this disclosure. The method 1300 identifies, by a system comprising at least one processor, video content at 1302 from media sources for generating, or communicating, the video content via a personalized video channel. For example, the media sources can comprise at least two of a broadcast media channel, a web page/site, a web data feed, a network subscription service, a social network feed, and/or a video library and the like.

At 1304, user profile data is generated based on a set of user preferences for the video content and a set of behavioral data that represents user control inputs related to the video content. The user preferences could be a genre, an audio word or phrase within the content, a title, a language spoken, an actor/actress present, a time/date for rendering via the personalized channel, and the like. The user preferences can include a classification criterion, for example, that comprises at least one of a theme, an age range, a media content rating, an actor or actress, a title, which is associated with the video content, and whether audio content of a video content portion matches a word or phrase of a search criteria represented in the user profile data.

The behavioral data can include activities of the user for determining what the user could be interested in, such as purchases made of video content, search terms or criteria for video content, activities during viewing of video content (e.g., skipping content, fast forwarding, etc.), and any control input to video content in response to rendering the video content via a personalized channel.

At 1306, a rendering of the video content is facilitated from the media sources by a display component via the personalized video channel based on the user profile data. The channel is personalized for rendering content from various sources at different times and operable to interact with the content through sharing, publishing to other devices, rendering in a view pane, further configuration (e.g., altering source during a particular time, modifying the video content form a particular source, etc.). In addition or alternatively, a personalized channel selection can be received as profile data that determines whether the video content of a first personalized video channel or a different video content of a second personalized video channel is sent to the display component for rendering in a display component for viewing.

In one embodiment, the method can include comparing the video content from the media sources to identify duplicate video content, and removing the duplicate video content from a set of video content selections, in order to provide video content and/or media sources of the respective content as selections for configuring the personalized channel based on user profile data. The removal of duplicates could be according to one or more criteria, such as bit rate, resolution and/or other video quality criteria for maintaining the video content having a greater quality of service than the duplicate video content. For example, the method could include analyzing the video content from the media sources to determine one or more video characteristics, such as bitrate, frame rate, frame size, audio content, formatting, a title, an actor and/or actress, and/or metadata pertaining to the video content. The analysis of video content can operate to enable further removal of duplicate video content.

In another embodiment, the method 1300 can further include partitioning of the video content into a plurality of video content portions based on a defined set of criteria that comprises at least one of a topic, an audio content, a transition point in the video content, a duration or time frame, a match of the set of user preferences of the user profile data or the audio content of the video content being determined to match a word or phrase of a search criterion of the defined set of criteria. The portions can include, for example, various programming sequences being broadcast from one or more of the media sources, and/or of entire video content, in which the portions are splices of subsets of the video content in order to facilitate rendering of only interesting sections according to user profile data.

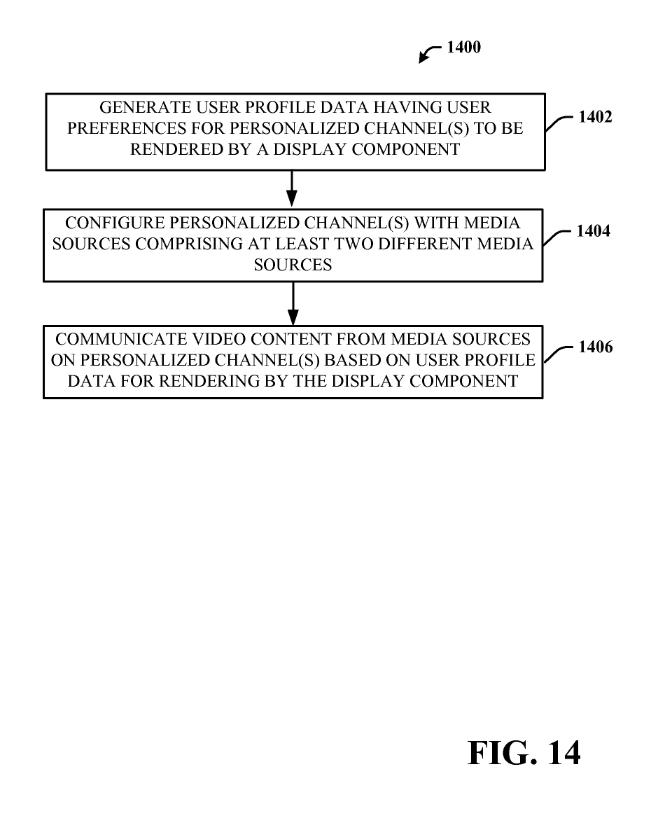

Referring to FIG. 14, illustrated is an exemplary system flow 1400 in accordance with embodiments described in this disclosure. The method 1400 generates user profile data having a set of user preferences for a set of personalized channels to be rendered by a display component. At 1404, the set of personalized channels is configured with media sources comprising at least two of a broadcast channel, a news data feed, a social data feed, a web site, a subscription broadcast service, a personal data store and/or the like. At 1406, video content is communicated from the media sources on the set of personalized channels based on the user profile data for rendering by the display component.

In one embodiment, configuring the set of personalized channels can include associating metadata with the video content or with at least one of the media sources from which the video content originate. The metadata can include information about the video content, a media source, and/or channel data (e.g., timing, scheduling, titles, etc.), in which the data can be associated from user preferences of the user profile data and/or manually associated with the video content and/or the media source. In addition, additional media sources can be added to the set of personalized channels as additional sources available are identified.

### Exemplary Networked and Distributed Environments

One of ordinary skill in the art can appreciate that the various non-limiting embodiments of the shared systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

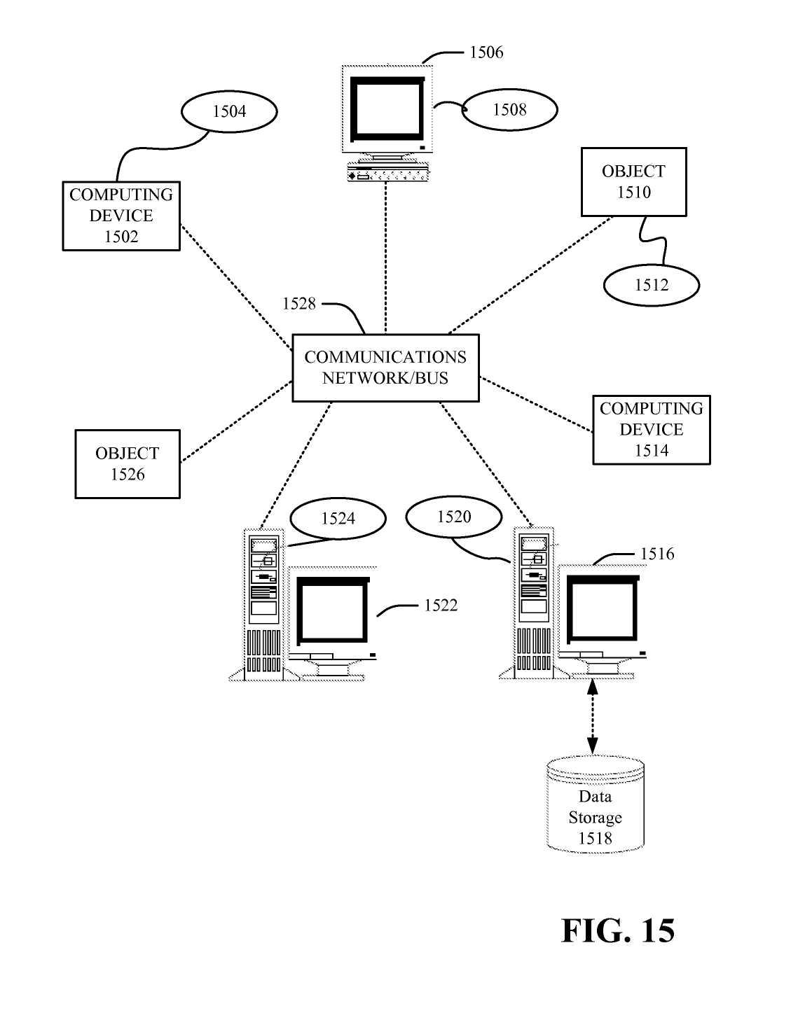

FIG. 15 provides a schematic diagram of an exemplary networked or distributed computing environment. The distributed computing environment comprises computing objects 1510, 1526, etc. and computing objects or devices 1502, 1506, 1510, 1514, etc., which may include programs, methods, data stores, programmable logic, etc., as represented by applications 1504, 1508, 1512, 1520, 1524. It can be appreciated that computing objects 1512, 1526, etc. and computing objects or devices 1502, 1506, 1510, 1514, etc. may comprise different devices, such as personal digital assistants (PDAs), audio/video devices, mobile phones, MP3 players, personal computers, laptops, etc.

Each computing object 1510, 1512, etc. and computing objects or devices 1520, 1522, 1524, 1526, etc. can communicate with one or more other computing objects 1510, 1512, etc. and computing objects or devices 1520, 1522, 1524, 1526, etc. by way of the communications network 1528, either directly or indirectly. Even though illustrated as a single element in FIG. 15, communications network 1528 may comprise other computing objects and computing devices that provide services to the system of FIG. 15, and/or may represent multiple interconnected networks, which are not shown. Each computing object 1510, 1526, etc. or computing object or device 1520, 1522, 1524, 1526, etc. can also contain an application, such as applications 1504, 1508, 1512, 1520, 1524, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 15, as a non-limiting example, computing objects or devices 1520, 1522, 1524, 1526, etc. can be thought of as clients and computing objects 1510, 1526, etc. can be thought of as servers where computing objects 1510, 1526, etc., acting as servers provide data services, such as receiving data from client computing objects or devices 1520, 1522, 1524, 1526, etc., storing of data, processing of data, transmitting data to client computing objects or devices 1520, 1522, 1524, 1526, 1528, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1540 or bus is the Internet, for example, the computing objects 1510, 1526, etc. can be Web servers with which other computing objects or devices 1520, 1522, 1524, 1526, etc. communicate via any of a number of known protocols, such as the hypertext transfer protocol (HTTP). Computing objects 1510, 1512, etc. acting as servers may also serve as clients, e.g., computing objects or devices 1520, 1522, 1524, 1526, etc., as may be characteristic of a distributed computing environment.

### Exemplary Computing Device

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting embodiments, i.e., anywhere that a device may wish to engage on behalf of a user or set of users. Accordingly, the below general purpose remote computer described below in FIG. 16 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 16 and the following discussion provide a brief, general description of a suitable computing environment to implement embodiments of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 16 illustrates an example of a system 1610 comprising a computing device 1612 configured to implement one or more embodiments provided herein. In one configuration, computing device 1612 includes at least one processing unit 1616 and memory 1618. Depending on the exact configuration and type of computing device, memory 1618 may be volatile (such as RAM, for example), non-volatile (such as ROM, flash memory, etc., for example) or some combination of the two. This configuration is illustrated in FIG. 16 by dashed line 1614.

In other embodiments, device 1612 may include additional features and/or functionality. For example, device 1612 may also include additional storage (e.g., removable and/or non-removable) including, but not limited to, magnetic storage, optical storage, and the like. Such additional storage is illustrated in FIG. 16 by storage 1620. In one embodiment, computer readable instructions to implement one or more embodiments provided herein may be in storage 1620. Storage 1620 may also store other computer readable instructions to implement an operating system, an application program, and the like. Computer readable instructions may be loaded in memory 1618 for execution by processing unit 1616, for example.

The term “computer readable media” as used herein includes computer storage media. Computer storage media includes volatile and nonvolatile, removable and non-removable media implemented in any method or technology for storage of information such as computer readable instructions or other data. Memory 1618 and storage 1620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1612. Any such computer storage media may be part of device 1612.

Device 1612 may also include communication connection(s) 1626 that allows device 1612 to communicate with other devices. Communication connection(s) 1626 may include, but is not limited to, a modem, a Network Interface Card (NIC), an integrated network interface, a radio frequency transmitter/receiver, an infrared port, a USB connection, or other interfaces for connecting computing device 1612 to other computing devices. Communication connection(s) 1626 may include a wired connection or a wireless connection. Communication connection(s) 1626 may transmit and/or receive communication media.

The term “computer readable media” as used herein includes computer readable storage media and communication media. Computer readable storage media includes volatile and nonvolatile, removable and non-removable media implemented in any method or technology for storage of information such as computer readable instructions or other data. Memory 1618 and storage 1620 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1612. Any such computer readable storage media may be part of device 1612.

Device 1612 may also include communication connection(s) 1626 that allows device 1612 to communicate with other devices. Communication connection(s) 1626 may include, but is not limited to, a modem, a Network Interface Card (NIC), an integrated network interface, a radio frequency transmitter/receiver, an infrared port, a USB connection, or other interfaces for connecting computing device 1612 to other computing devices. Communication connection(s) 1626 may include a wired connection or a wireless connection. Communication connection(s) 1626 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 1612 may include input device(s) 1624 such as keyboard, mouse, pen, voice input device, touch input device, infrared cameras, video input devices, and/or any other input device. Output device(s) 1622 such as one or more displays, speakers, printers, and/or any other output device may also be included in device 1612. Input device(s) 1624 and output device(s) 1622 may be connected to device 1612 via a wired connection, wireless connection, or any combination thereof. In one embodiment, an input device or an output device from another computing device may be used as input device(s) 1624 or output device(s) 1622 for computing device 1612.

Components of computing device 1612 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1612 may be interconnected by a network. For example, memory 1618 may be comprised of multiple physical memory units located in different physical locations interconnected by a network.

Those skilled in the art will realize that storage devices utilized to store computer readable instructions may be distributed across a network. For example, a computing device 1630 accessible via network 1628 may store computer readable instructions to implement one or more embodiments provided herein. Computing device 1612 may access computing device 1630 and download a part or all of the computer readable instructions for execution. Alternatively, computing device 1612 may download pieces of the computer readable instructions, as needed, or some instructions may be executed at computing device 1612 and some at computing device 1630.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A system, comprising:
a memory that stores computer-executable components; and
a processor, communicatively coupled to the memory, that facilitates execution of the computer-executable components, the computer-executable components comprising:
a source component configured to identify video content from a plurality of media sources comprising at least two of a wireless broadcast media channel, a web site, a web data feed, or a wired broadcast channel for communication via a personalized video channel;
a demographic component configured to classify a user device in a demographic class based on demographic data;
a prediction component configured to generate a set of predicted video content from the video content of the plurality of media sources based on the demographic data; and
a streaming component configured to communicate the set of predicted video content from the plurality of media sources to a mobile component via the personalized video channel and re-configure the personalized video channel to communicate, at different times, the video content identified from different media sources of the plurality of media sources.

2. The system of claim 1, wherein the demographic data comprises a geographical location including a political region, a time, a date, and statistical data of viewing preferences related to at least one of the geographical location, the time or the date.

3. The system of claim 1, wherein the demographic component is further configured to modify the demographic class based on a change in the demographic data.

4. The system of claim 1, the computer-executable components further comprising:
a profile component configured to generate user profile data based on a set of user preferences related to the video content and a set of behavioral data representing user control inputs related to the video content.

5. The system of claim 4, wherein the prediction component is further configured to generate the set of predicted video content based on the demographic data and the user profile data.

6. The system of claim 5, the computer-executable components further comprising:
a weighting component configured to associate a first weight measure to the demographic data and a second weight measure to the user profile data, and modify the first weight measure and the second weight measure based on a predetermined threshold amount of user profile data that is generated.

7. The system of claim 1, the computer-executable components further comprising:
a scheduling component configured to generate a programming schedule for the set of predicted video content based on the demographic data that comprises statistical data of viewing preferences related to at least one of a geographical location, a time or a date.

8. The system of claim 7, the computer-executable components further comprising:
a programming component configured to identify scheduling data corresponding to at least part of the video content from media information sources,
wherein the scheduling component is further configured to generate the programming schedule further based on the scheduling data corresponding to the at least part of the video content.

9. The system of claim 8, wherein the media information sources comprise the plurality of media sources and an additional media sources that generates open source data for at least one wireless broadcast channel or the wired broadcast channel.

10. The system of claim 8, the computer-executable components further comprising:
a genre component configured to generate classifications of the video content from the plurality of media sources based on a plurality of genres,
wherein the scheduling component is further configured to generate the programming schedule further based on the classifications.

11. The system of claim 1, the computer-executable components further comprising:
a prediction grid component configured to communicate a prediction grid via the personalized video channel that includes different predicted video content of the set of predicted video content along a time line that comprises past predicted content, current predicted content and future predicted content for selected points along the time line.

12. The system of claim 1, the computer-executable components further comprising:
a chat component configured to communicate a chat screen via the personalized video channel to at least two mobile devices receiving the video content from the plurality of media sources via the personalized video channel.

13. The system of claim 12, wherein the chat screen comprises a video chat screen for generating a video chat session.

14. The system of claim 1, wherein the plurality of media sources further comprises a personalized video store having a set of personalized video content that is communicated via the personalized video channel to a set of mobile devices.

15. The system of claim 14, wherein the streaming component is further configured to communicate the set of personalized video content at a different time than the video content from the plurality of media sources.

16. The system of claim 1, the computer-executable components further comprising:
a scheduling component configured to personalize the personalized video channel with the video content corresponding to a selected time and a selected media source of the plurality of media sources.

17. The system of claim 1, the computer-executable components further comprising:
a feedback component configured to communicate a set of video content options that correspond to a modification of the demographic data, wherein the set of video content options comprise additions or deletions to at least one of the video content, the plurality of media sources, or a scheduled time for rendering the video content via the personalized video channel.

18. The system of claim 1, the computer-executable components further comprising:
a publishing component configured to publish a scheduling of the video content and the plurality of media sources of the plurality of media sources to a network.

19. The system of claim 1, the computer-executable components further comprising:
a social group component configured to receive a request from different mobile devices to communicate the video content from the plurality of media sources.

20. A method, comprising:
identifying, by a system comprising at least one processor, video content from a plurality of media sources for configuring a personalized video channel;
generating a set of demographic data related to a mobile device that is authorized to configure the personalized video channel with a first video content from a first media source of the plurality of media sources at a first time and a second video content from a second media source of the plurality of media sources at a second time;
generating a set of predicted video content from the video content of the plurality of media sources based on the set of demographic data; and
streaming the set of predicted video content to the mobile device via the personalized video channel.

21. The method of claim 20, wherein the plurality of media sources comprise at least two of a broadcast media channel, a web page, a web data feed, a network subscription service or a video library, and the set of demographic data comprises a geographical location including a political region, a time, a date, and statistical data of viewing preferences related to at least one of the geographical location, the time or the date.

22. The method of claim 20, further comprising:
generating user profile data based on a set of user preferences related to the video content and a set of behavioral data representing user control inputs related to the video content.

23. The method of claim 22, further comprising:
associating a weighting measure to the set of demographic data and to the user profile data respectively.

24. The method of claim 23, wherein the generating the set of predicted video content is based on the set of demographic data, the user profile data and the weighting measure respectively, wherein the weighting measure is modified based on an amount of user profile data generated.

25. The method of claim 20, further comprising:
generating a programming schedule for the set of predicted video content based on the set of demographic data that comprises statistical data of viewing preferences related to at least one of a geographical location, a time or a date.

26. The method of claim 20, further comprising:
communicating a prediction grid via the personalized video channel that comprises different predicted video content of the set of predicted video content along a time line that comprises past predicted content, current predicted content and future predicted content that corresponds to selected points along the time line.

27. The method of claim 20, further comprising:
communicating a chat screen via the personalized video channel to at least two mobile devices receiving the video content from the plurality of media sources via the personalized video channel.

28. The method of claim 20, further comprising:
associating a genre classification to the video content from the plurality of media sources; and
configuring the personalized video channel based on the genre classification of the video content for defined times.

29. The method of claim 20, further comprising:
configuring the personalized video channel to communicate the video content from the plurality of media sources at defined times based on user profile data that includes a set of user preferences and a set of behavioral data, wherein the set of user preferences comprise least one of a media source preference, a time preference to associate with the video content, a personalized channel selection, a theme preference, a rating preference, an actor preference, a language preference or a date preference, and the set of behavioral data comprises at least one of purchasing date, viewing data, search data, purchase data, location data, language data, age data, household membership data or subscription data, and at least one user input control related to the set of predicted video content being communicated via the personalized video channel.

30. The method of claim 20, further comprising:
receiving a request from a different mobile device to receive the first video content or the second video content at a defined time via the personalized video channel.

31. A tangible computer readable medium comprising computer executable instructions that, in response to execution, cause a computing system comprising at least one processor to perform operations, comprising:
determining a set of demographic data related to a mobile device for configuring a personalized video channel in communication with the mobile device;
identifying a plurality of media sources comprising at least two of a broadcast media channel, a web page, a web data feed, a network subscription service or a video library; and
configuring the personalized video channel based on the set of demographic data to communicate video content from the plurality of media sources at defined times.

32. The tangible computer readable medium of claim 31, wherein the set of demographic data comprises a geographical location including a political region, a time, a date, and statistical data of viewing preferences related to at least one of the geographical location, the time or the date.

33. The tangible computer readable medium of claim 32, the operations further comprising:
determining user profile data based on a set of user preferences related to the video content and a set of behavioral data representing user control inputs related to the video content.

34. The tangible computer readable medium of claim 33, the operations further comprising:
re-configuring the personalized video channel based on the user profile data to communicate the video content of a different media source for a defined time of the defined times.

35. The tangible computer readable medium of claim 34, the operations further comprising:
communicating a chat screen to at least two mobile devices receiving the video content from the plurality of media sources via the personalized video channel.

36. The tangible computer readable medium of claim 31, the operations further comprising:
associating a genre classification to the video content from the plurality of media sources, wherein the configuring the personalized video channel is based on the genre classification of the video content for the defined times.
